(19) United States
(12) Patent Application Publication
(10) Pub. No.: US 2008/0147763 A1
(43) Pub. Date: Jun. 19, 2008

(54) METHOD AND APPARATUS FOR USING STATE SPACE DIFFERENTIAL GEOMETRY TO PERFORM NONLINEAR BLIND SOURCE SEPARATION

(76) Inventor: David Levin, Chicago, IL (US)

Correspondence Address: BRINKS HOFER GILSON & LIONE, P.O. BOX 10395, CHICAGO, IL, 60610, US

(21) Appl. No.: 11/952,284

(22) Filed: Dec. 7, 2007

Related U.S. Application Data
(60) Provisional application No. 60/870,529, filed on Dec. 18, 2006.

(51) Int. Cl. G06F 17/14

(52) U.S. Cl. 708/400

(57) ABSTRACT

Given a time series of possibly multicomponent input data, the method and apparatus includes a device that finds a time series of “source” components, which are possibly nonlinear combinations of the input data components and which can be partitioned into groups that are statistically independent of one another. These groups of source components are statistically independent in the sense that the phase space density function of the source time series is approximately equal to the product of density functions, each of which is a function of the components (and their time derivatives) in one of the groups. In a specific embodiment, an unknown mixture of data from multiple independent source systems (e.g., a transmitter of interest and noise producing system) is processed to extract information about at least one source system (e.g., the transmitter of interest).

This application claims the benefit of priority from Provisional Application Ser. No. 60/870,529, filed on Dec. 18, 2006, which is hereby incorporated by reference in its entirety.

### FIELD OF THE INVENTION

This disclosure relates generally to a method and apparatus that performs nonlinear “blind source separation” (BSS). More specifically, given a time series of input data, this disclosure relates to a method and apparatus for determining possibly nonlinear combinations of the input data that can be partitioned into statistically independent groups.

### BACKGROUND OF THE INVENTION

Consider a set of input data consisting of \tilde{x}(t), a time-dependent multiplet of n components (\tilde{x}ₖ for k=1, 2, . . . , n). The usual objectives of nonlinear BSS are: 1) to determine if these data are instantaneous mixtures of source components that can be partitioned into statistically independent groups; i.e., to determine if

\tilde{x}(t)=f[x(t)], (Eq. 1)

where x(t) is the source time series and f is an unknown, possibly nonlinear, n-component mixing function, and, if so, 2) to compute the mixing function. In most approaches to this problem, the source components are required to be statistically independent in the sense that their density function ρ(x) is the product of the density functions of mutually exclusive groups of components

ρ(x)=ρ_{A}(x_{A})ρ_{B}(x_{B}) (Eq. 2)

where x_{A}, x_{B}, . . . are comprised of mutually exclusive groups of components of x. However, it is well known that this problem always has multiple solutions. Specifically, the density function of any observed input data can be integrated in order to construct an entire family of mixing functions that transform it into separable (i.e., factorizable) forms. In many practical applications, the input data are an unknown mixture of data from multiple independent source systems, and it is desired to extract unmixed data from one of the source systems (up to unknown transformations of that system's data). In general, the data from the source system of interest will be represented by a group of components of one of the many combinations of input data satisfying Eq.(2). Thus, the criterion of statistical independence in Eq.(2) is too weak to uniquely determine the mixing function and the source system data that are sought in many applications.

Furthermore, suppose that one ignores this issue of non-uniqueness and merely seeks to find just one of the (possibly extraneous) mixing functions satisfying Eq.(2). There is no generally applicable method of achieving even this limited objective. For example, many existing methods attempt to find mixing functions that satisfy higher-order statistical consequences of Eq.(2), and this often requires using approximations of uncertain validity. For instance, it may be necessary to assume that the mixing function can be parameterized (e.g., by a specific type of neural network architecture or by other means), and/or it may be necessary to assume that the mixing function can be derived by iterative methods or probabilistic learning methods. Alternatively, more analytic methods can be used at the cost of assuming that the mixing function belongs to a particular class of functions (e.g., post-nonlinear mixtures). Because of such assumptions and because of the non-uniqueness issue, existing techniques of nonlinear BSS are only useful in a limited domain of applications.

### SUMMARY

The observed trajectories of many classical physical systems can be characterized by density functions in phase space (i.e., (\tilde{x}, [symbol] -space). Furthermore, if such a system is composed of non-interacting subsystems (A, B, . . . ), the state space variables \tilde{x} can always be transformed to source variables x for which the system's phase space density function is separable (i.e., is the product of the phase space density functions of the subsystems)

ρ(x,\dot{x})=ρ_{A}(x_{A}, \dot{x}_{A})ρ_{B}(x_{B}, \dot{x}_{B}) (Eq. 3)

This fact motivates the method and apparatus for BSS (FIG. 1) comprising this disclosure: we search for a function of the input data \tilde{x}(t) that transforms their phase space density function \tilde{ρ}(\tilde{x}, [symbol] ) into a separable form. Unlike conventional BSS, this “phase space BSS problem” almost always has a unique solution in the following sense: in almost all cases, the data are inseparable, or they can be separated by a mixing function that is unique, up to transformations that do not affect separability (permutations and possibly nonlinear transformations of each statistically independent group of source components). This form of the BSS problem has a unique solution in almost all cases because separability in phase space (Eq.(3)) is a stronger requirement than separability in state space (Eq.(2)). As mentioned above, in many practical applications, the input data are an unknown mixture of data from multiple independent source systems, and it is desired to determine unmixed data from one source system of interest. This disclosure teaches that, in most cases, the desired source system data are components of the unique source variables that satisfy Eq.(3).

Furthermore, in contrast to previous BSS methods, this disclosure (FIG. 1) teaches a generally applicable technique for determining the source variables. Specifically, this disclosure teaches that the phase space density function of a time series of input data induces a Riemannian geometry on the input data's state space and that its metric can be directly computed from the local velocity correlation matrix of the input data. This disclosure teaches how this differential geometry can be used to determine if the data are separable, and, if they are separable, it teaches how to explicitly construct source variables. In other words, unlike previous approaches to BSS, this disclosure teaches a method of solving the BSS problem in rather general circumstances.

It is useful to compare the technical characteristics of this disclosure and previous BSS methods. As shown in Section I, this disclosure exploits statistical constraints on source time derivatives that are locally defined in the state space, in contrast to previous art in which the criteria for statistical independence are global conditions on the source time series or its time derivatives. Furthermore, this disclosure unravels the nonlinearities of the mixing function by imposition of local second-order statistical constraints, unlike previous art that teaches the use of higher-order statistical constraints. In addition, this disclosure uses the constraints of statistical independence to construct the mixing function in a “deterministic” manner, without the need for parameterizing the mixing function (with a neural network architecture or other means), without using probabilistic learning methods, and without using iterative methods, as taught by previous art. And, unlike some previous art that only applies to a restricted class of mixing functions, this disclosure can treat any differentiable invertible mixing function. Finally, this disclosure applies differential geometry in a manner that is different from the application of differential geometry to BSS in previous art. In this disclosure, the observed data trajectory is used to derive a metric on the system's state space. In contrast, previous art teaches a metric on a completely different space, the search space of possible mixing functions, and then uses that metric to perform “natural” (i.e., covariant) differentiation in order to expedite the search for the function that optimizes the fit to the observed data.

Other systems, methods, features, and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like-referenced numerals designate corresponding parts throughout the different views.

FIG. 1 is a pictorial diagram of a specific embodiment of a device, according to this disclosure, in which input data, representing a mixture of information from multiple independent source systems, are processed in order to identify information about individual source systems;

FIG. 2 is a pictorial diagram of a differential geometric method for one-dimensional BSS;

FIG. 3 is a pictorial diagram of a differential geometric method for multidimensional BSS;

FIG. 4a is a pictorial illustration of the first three principal components of log filterbank outputs derived from a typical six-second segment of a synthetic recording;

FIG. 4b is a pictorial illustration of the trajectory in FIG. 4a after dimensional reduction to the space (\tilde{x}) of input data;

FIG. 4c is a pictorial illustration of one of the statistically-independent source time series blindly derived from the input data in FIG. 4b;

FIG. 4d is a pictorial illustration of the other statistically-independent source time series blindly derived from the input data in FIG. 4b;

FIG. 4e is a pictorial illustration of the state variable time series used to synthesize the utterances of one of the two voices;

FIG. 4f is a pictorial illustration of the state variable time series used to synthesize the utterances of the other of the two voices;

FIG. 5 is a pictorial illustration of a small sample of the trajectory segments (thin black curved lines) traversed by the particle that was confined to a spherical surface and of the corresponding trajectory segments (long thick black line) of the second particle constrained to a straight line. The stimulus was “watched” by five simulated pinhole cameras. Each small triplet of orthogonal straight lines shows the relative position and orientation of a camera, with the long thick line of each triplet being the perpendicular to a camera focal plane that was represented by the two short thin lines of each triplet. One camera is nearly obscured by the spherical surface. The thick gray curved lines show some latitudes and longitudes on the spherical surface;

FIG. 6a is a pictorial illustration of a small sample of trajectory segments of the 20-dimensional camera outputs of the system in FIG. 5. Only the first three principal components are shown;

FIG. 6b is a pictorial illustration of a small sample of trajectory segments of the system in FIG. 5, after dimensional reduction was used to map them from the 20-dimensional space of camera outputs onto the three-dimensional space (\tilde{x}) of input data;

FIG. 6c is a pictorial illustration of a small sample of trajectory segments of the system in FIG.5, after they were transformed from the \tilde{x} coordinate system to the geodesic (s) coordinate system (i.e., the “experimentally” determined source coordinate system);

FIG. 7a is a pictorial illustration of test lines, defined in the “laboratory” coordinates in FIG. 5, after they were mapped into the 20-dimensional space of camera outputs. The figure only depicts the resulting pattern's projection onto the space of the first three principal components of the 20-dimensional system trajectory;

FIG. 7b is a pictorial illustration of the test lines in FIG. 7a, after dimensional reduction was used to map them from the 20-dimensional space of camera outputs onto the three-dimensional space (\tilde{x}) of input data traversed by the trajectory segments;

FIG. 7c is a pictorial illustration of the test pattern (thin black lines) in FIG. 7b , after it was transformed from the \tilde{x} coordinate system to the geodesic (s) coordinate system, which comprises the “experimentally” derived source coordinate system. The thick gray lines show the test lines in the comparable exact source coordinate system; and

FIG. 7d is a pictorial illustration of the first two components (thin and thick lines) of the test pattern in FIG. 7c. These collections of lines represent the projection of the test pattern onto the “experimentally” derived two-dimensional source subspace and onto the exactly known source subspace, respectively.

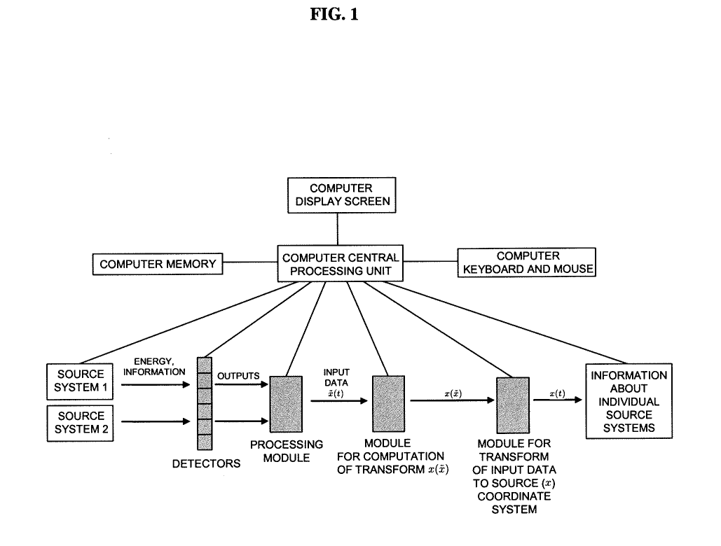

### DETAILED DESCRIPTION

### I. Procedure for Blind Source Separation

### I.A. One-Dimensional Blind Source Separation

This subsection describes how to determine if input data are an instantaneous, possibly nonlinear mixture of source components, each of which is statistically independent of the others. If such a separation is possible, this subsection also shows how to compute the mixing function. The resulting mixing function is unique, up to transformations that do not affect separability (permutations and component-wise transformations).

The method described may be performed on a variety of computers or computer systems. The computer system may include various hardware components, such as RAM ROM, hard disk storage, cache memory, database storage, and the like, as is known in the art. The computer system may include any suitable processing device, such as a computer, microprocessor, RISC processor (reduced instruction set computer), CISC processor (complex instruction set computer), mainframe computer, work station, single-chip computer, distributed processor, server, controller, micro-controller, discrete logic computer and the like, as is known in the art. For example, the processing device may be an Intel Pentium® microprocessor, x86 compatible microprocessor, or other device.

The computer system may include any suitable storage components, such as RAM, EPROM (electrically programmable ROM), flash memory, dynamic memory, static memory, FIFO (first-in first-out) memory, LIFO (last-in first-out) memory, circular memory, semiconductor memory, bubble memory, buffer memory, disk memory, optical memory, cache memory, and the like. Any suitable form of memory may be used whether fixed storage on a magnetic medium, storage in a semiconductor device or remote storage accessible through a communication link. The computer system may include a interface, which may communicate with the keyboard, mouse and suitable output devices. The output devices may include an LCD display, a CRT, various LED indicators and/or a speech output device, as is known in the art.

The computer system may includes a communication interface to permit the computer system to communicate with external sources. The communication interface may be, for example, a local area network, as an Ethernet network, intranet, Internet or other suitable network. The communication interface may also be connected to a public switched telephone network (PSTN) or POTS (plain old telephone system), which may facilitate communication via the Internet. Dedicated and remote networks may also be employed and the system may further communicate with external exchanges and sources of information. Any suitable commercially available communication device or network may be used, as is known in the art.

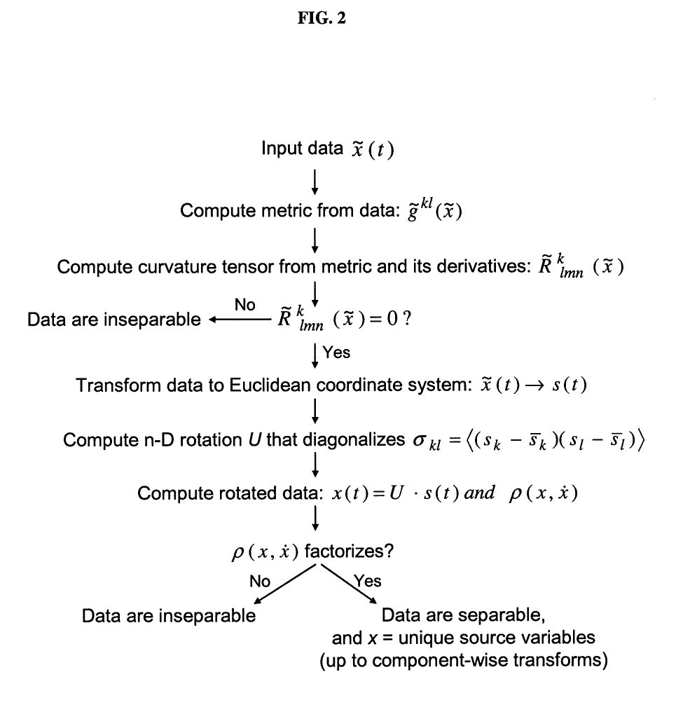

FIG. 2 illustrates the procedure for achieving these objectives. Let x=x(t) (xₖ for k=1, 2, . . . , n) denote the trajectory of a time series in some (x) coordinate system. Suppose that the trajectory densely covers a patch of (x, \dot{x})-space (i.e., phase space), and suppose that there is a phase space density function ρ(x, \dot{x}), which measures the fraction of total time that the trajectory spends in each small neighborhood dxd\dot{x}. As discussed in Section II.A, the trajectory of the evolving state of a classical physical system in thermal equilibrium with a “bath” will have such a phase space density function: namely, the Maxwell-Boltzmann distribution. Next, define g^{kl}(x) to be the local second-order velocity correlation matrix

g^{kl}(x)=<(\dot{x}ₖ− [symbol] )(\dot{x}ₗ− [symbol] )>x (Eq. 4)

where the bracket denotes the time average over the trajectory's segments in a small neighborhood of x and where [symbol] =<\dot{x}>ₓ is the local time average of \dot{x}. This means that g^{kl} is a combination of first and second moments of the local velocity distribution described by ρ. Because this correlation matrix transforms as a symmetric contravariant tensor, it can be taken to be a contravariant metric on the state space. Furthermore, as long as the local velocity distribution is not confined to a hyperplane in velocity space, this tensor is positive definite and can be inverted to form the corresponding covariant metric gₖₗ. Thus, under these conditions, the time series induces a non-singular metric on state space. This metric can then be differentiated to compute the affine connection Γₗₘ^{k}(x) and Riemann-Christoffel curvature tensor R^{k}ₗₘₙ(x) of state space by means of the standard formulas of differential geometry (Eqs.(13, 14)).

Now, assume that we have a set of input data \tilde{x}(t) that are separable; i.e., assume that there is a set of source variables x for which the phase space density function ρ is equal to the product of density functions of each individual component of x. It follows from Eq.(4) that the metric g^{kl}(x) is diagonal and has positive diagonal elements, each of which is a function of the corresponding coordinate component. Therefore, the individual components of x can be transformed in order to create a new “Euclidean” source coordinate system in which the metric is the identity matrix and in which the curvature tensor vanishes everywhere. It follows that the curvature tensor must vanish in every coordinate system, including the coordinate system \tilde{x} defined by the input data

\tilde{R}^{k}ₗₘₙ(\tilde{x})=0. (Eq. 5)

In other words, the vanishing of the curvature tensor is a necessary consequence of separability. Therefore, if this data-derived quantity does not vanish, the input data cannot be transformed so that their phase space density function factorizes.

On the other hand, if the data do satisfy Eq.(5), there is only one possible separable coordinate system (up to transformations that do not affect separability), and it can be explicitly constructed from the input data \tilde{x}(t). To see this, assume that the input data satisfy Eq.(5), and note two properties of such a flat manifold with a positive definite metric: 1) it is always possible to explicitly construct a Euclidean coordinate system for which the metric is the identity matrix; 2) if any other coordinate system has a diagonal metric with positive diagonal elements that are functions of the corresponding coordinate components, it can be derived from this Euclidean one by means of an n-dimensional rotation, followed by transformations that do not affect separability (permutations and transformations of individual components). Therefore, because every separable coordinate system must have a diagonal metric with the aforementioned properties, all possible separable coordinate systems can be found by constructing a Euclidean coordinate system and then finding all rotations of it that are separable. The first step is to construct a Euclidean coordinate system in the following manner: at some arbitrarily-chosen point \tilde{x}₀, select n vectors δ\tilde{x}₍ᵢ₎ (i=1, 2, . . . , n) that are orthogonal with respect to the metric at that point (i.e., \tilde{g}ₖₗ(\tilde{x}₀)δ\tilde{x}₍ᵢ₎ₖδ\tilde{x}₍ⱼ₎ₜ=λ²δᵢⱼ, where λ is a small number, δᵢⱼ is the Kronecker delta, and repeated indices are summed). Then, 1) starting at \tilde{x}₀, use the affine connection to repeatedly parallel transfer all δ\tilde{x}₍ᵢ₎ along δ\tilde{x}₍₁₎; 2) starting at each point along the resulting geodesic path, repeatedly parallel transfer these vectors along δ\tilde{x}₍₂₎; . . . continue the parallel transfer process along directions δ\tilde{x}₍₃₎ . . . δ\tilde{x}₍ₙ₋₁₎ . . . ; n) starting at each point along the most recently produced geodesic path, parallel transfer these vectors along δ\tilde{x}₍ₙ₎. Finally, each point is assigned the geodesic coordinate s (sₖ, k=1, 2, . . . , n), where sₖ represents the number of parallel transfers of the vector δ\tilde{x}₍ₖ₎ that was required to reach it. Given Eq.(5), differential geometry guarantees that the metric will be a multiple of the identity matrix in the geodesic coordinate system constructed in this way. We can now transform the data into the corresponding Euclidean coordinate system and examine the separability of all possible rotations of it. The easiest way to do this is to compute the global second-order correlation matrix

σₖₗ=<(sₖ−\tilde{s}ₖ)(sₗ−\tilde{s}ₗ)>, (Eq. 6)

where the brackets denote the time average over the entire trajectory and \tilde{s}=<s>. If this data-derived matrix is not degenerate, there is a unique rotation U that diagonalizes it, and the corresponding rotation of the s coordinate system, x=Us, is the only candidate for a separable coordinate system (up to transformations that do not affect separability).

In principle, the separability of the data in this rotated coordinate system can be determined by explicitly computing the data's phase space density function in order to see if it factorizes. Alternatively, suppose that the amount of data is insufficient to accurately calculate the phase space density function of x(t). Then, the statistical independence of the x coordinates can be assessed by determining if higher-order correlations of x and \dot{x} components with non-identical indices factorize into products of lower-order correlations, as required by Eq.(3).

### I.B. Multidimensional Blind Source Separation

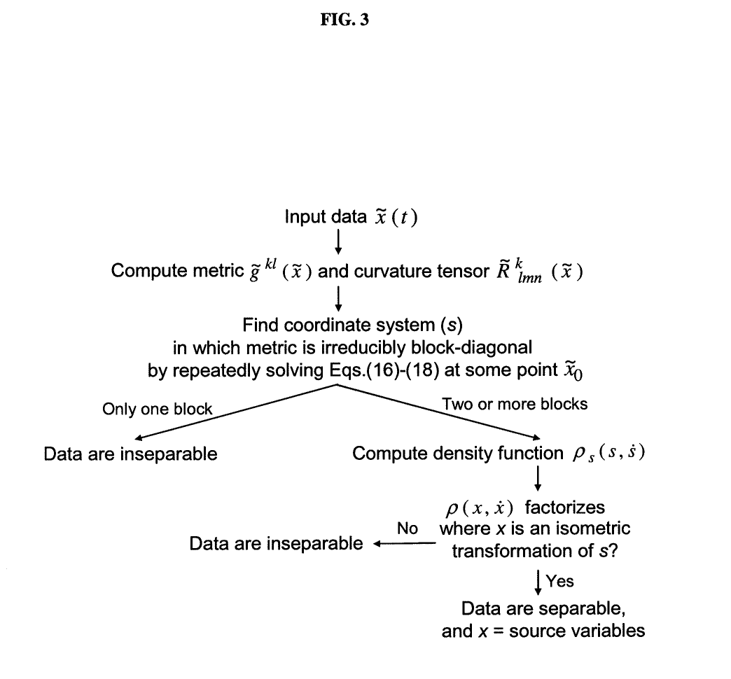

This subsection describes the solution of a more general BSS problem in which the source components are only required to be partitioned into groups, each of which is statistically independent of the others but each of which may contain statistically dependent components. FIG. 3 summarizes the multidimensional BSS method described in this subsection. This procedure is illustrated with analytic and numerical examples in Sections II.A and II.C, respectively.

Let \tilde{x}(t) (\tilde{x}ₖ for k=1, 2, . . . , n) denote a time series of input data. Suppose that we want to determine if these data are instantaneous mixtures of source variables x(t), having a factorizable density function

ρ(x, \dot{x})=ρ_{A}(x_{A}, \dot{x}_{A})ρ_{B}(x_{B}, \dot{x}_{B}), (Eq. 7)

where x_{A} and x_{B} contain components of x with indices x_{Ak}=Xₖ for k=1, 2, . . . n_{A}<n and x_{Bk}=xₖ for k=n_{A}+1, n_{A}+2, . . . , n_{A}+n_{B}=n. A necessary consequence of Eq.(7) is that the metric given by Eq.(4) is block-diagonal in the x coordinate system; i.e.,

$${g}_{kl} ( x ) = {( \begin{matrix}{g}_{A} ( {x}_{A} ) & 0 \\ 0 & {g}_{B} ( {x}_{B} )\end{matrix} )}_{kl} \qquad ( Eq . 8 )$$

where g_{A} and g_{B} are n_{A}×n_{A} and n_{B}×n_{B} matrices and each 0 symbol denotes a null matrix of appropriate dimensions. Notice that the metric in Eq.(8) is a diagonal array of blocks, each of which is a function of the corresponding block of coordinates. In the following, we use the term “block-diagonal” to refer to metrics with this property. The necessary condition for separability in Eq.(8) suggests the following strategy. The first step is to find the transformation from the data-defined coordinate system x to a coordinate system in which the metric is irreducibly block-diagonal everywhere in state space (irreducibly block-diagonal in the sense that each block cannot be further block-diagonalized). If there is a source coordinate system, the x_{A} source variable may include the coordinate components in a group of these irreducible blocks (or mixtures of the components in a group of such blocks), and the x_{B} source variable may consist of mixtures of the coordinate components in the complimentary group of blocks. Therefore, once the irreducibly block-diagonal coordinate system has been found, the BSS problem is reduced to the following tasks: 1) transform the density function into that coordinate system; 2) determine if the density function is the product of factors, each of which is a function of the coordinate components in one group of a set of mutually exclusive groups of blocks. If the density function does not factorize in the irreducibly block-diagonal coordinate system, the data are simply not separable.

The first step is to transform the metric into an irreducibly block-diagonal form. To begin, we assume that the metric can be transformed into a block-diagonal form with two, possibly reducible blocks (Eq.(8)), and then we derive necessary conditions that follow from that assumption. It is helpful to define the A (B) subspace at each point x to be the hyperplane through that point with constant x_{B} (x_{A}). A vector at x is projected onto the A subspace by the n×n matrix A^{k}ₗ

$${A}_{l}^{k} ( x ) = {( \begin{matrix}1 & 0 \\ 0 & 0\end{matrix} )}_{kl} \qquad ( Eq . 9 )$$

where 1 is the n_{A}×n_{A} identity matrix. For example, if \dot{x} is the velocity of the data's trajectory at x, then A^{k}_{l\dot{x}l} is the velocity's component in the A subspace, where we have used Einstein's convention of summing over repeated indices. The complementary projector onto the B subspace is B^{k}ₗ=δ^{k}ₗ−A^{k}ₗ, where δ^{k}ₗ, is the Kronecker delta. In any other coordinate system (e.g., the \tilde{x} coordinate system), the corresponding projectors (Ã^{k}ₗ and \tilde{B}^{k}ₗ) are mixed-index tensor transformations of the projectors in the x coordinate system; for example,

$${\tilde{A}}_{l}^{k} ( \tilde{x} ) = \frac{\partial {\tilde{x}}_{k}}{\partial {x}_{{k}^{′}}} \frac{\partial {x}_{{l}^{′}}}{\partial {\tilde{x}}_{l}} {A}_{{l}^{′}}^{{k}^{′}} ( x ) . \qquad ( Eq . 10 )$$

Because the A and B projectors permit the local separation of the A and B subspaces, it will be useful to be able to construct them in the measurement (\tilde{x}) coordinate system. Our strategy for doing this is to find conditions that the projectors must satisfy in the x coordinate system and then transfer those conditions to the \tilde{x} coordinate system by writing them in coordinate-system-independent form. First, note that Eq.(9) implies that A^{k}ₗ is idempotent

A^{k}_{k′}(x)A^{k′}ₗ(x)=A^{k}ₗ(x), (Eq. 11)

its “trace” is an integer

A^{k}ₖ(x)=n_{A}, (Eq. 12)

and it is unequal to the identity and null matrices. Next, consider the Riemann-Christoffel curvature tensor of the stimulus state space

$${R}_{lmn}^{k} ( x ) = - \frac{\partial {Γ}_{lm}^{k}}{\partial {x}_{n}} + \frac{\partial {Γ}_{ln}^{k}}{\partial {x}_{m}} + {Γ}_{im}^{k} {Γ}_{ln}^{i} - {Γ}_{in}^{k} {Γ}_{l m}^{i} \qquad ( Eq . 13 )$$

where the affine connection Γₗₘ^{k} is defined in the usual way

$${Γ}_{l m}^{k} ( x ) = \frac{1}{2} {g}^{kn} ( \frac{\partial {g}_{nl}}{\partial {x}_{m}} + \frac{\partial {g}_{n m}}{\partial {x}_{l}} - \frac{\partial {g}_{l m}}{\partial {x}_{n}} ) . \qquad ( Eq . 14 )$$

The block-diagonality of gₖₗ in the x coordinate system implies that Γₗₘ^{k} and R^{k}ₗₘₙ are also block-diagonal in all of their indices. The block-diagonality of the curvature tensor, together with Eq.(9), implies

R^{j}ₖₗₘ(x)A^{k}ᵢ(x)−A^{j}ₖ(x)R^{k}ᵢₗₘ(x)=0 (Eq. 15)

at each point x. Covariant differentiation of Eq.(15) will produce other local conditions that are necessarily satisfied by data with a block-diagonalizable metric. It can be shown that these conditions are also linear algebraic constraints on the subspace projector because the projector's covariant derivative vanishes.

Notice that both sides of Eqs.(11, 12) and (15) transform as tensors when the coordinate system is changed. Therefore, these equations must be true in any coordinate system on a space with a block-diagonalizable metric. In particular, in the x coordinate system that is defined by the observed input data, we have

Ã^{k}_{k′}(\tilde{x})Ã^{k′}ₗ(\tilde{x})=Ã^{k}ₗ(\tilde{x}) (Eq. 16)

Ã^{k}ₖ(\tilde{x})=n_{A}, (Eq. 17)

\tilde{R}^{j}ₖₗₘ(\tilde{x})Ã^{k}ᵢ(\tilde{x})−Ã^{j}ₖ(\tilde{x})\tilde{R}^{k}ᵢₗₘ(\tilde{x})=0, (Eq. 18)

where 1≦n_{A}<n. So far, we have shown that, if the metric can be transformed into the form in Eq.(8), there must necessarily be solutions of Eqs.(16-18). Thus, block-diagonalizability imposes a significant constraint on the curvature tensor of the space and, therefore, on the observed data.

What is the intuitive meaning of Eq.(18)? Because of the block-diagonality of the affine connection in the x coordinate system, it is easy to see that parallel transfer of a vector lying within the A (or B) subspace at any point produces a vector within the A (or B) subspace at the destination point. Consequently, the corresponding projectors (Ã^{k}ₗ and \tilde{B}^{k}ₗ) at the first point parallel transfer into themselves at the destination point. In particular, parallel transferring one of these projectors along the i^{th} direction and then along the j^{th} direction will give the same result as parallel transferring it along the j^{th} direction and then along the i^{th} direction. It is not hard to show that Eq.(18) is a statement of this fact: namely, block-diagonalizable manifolds support local projectors that are parallel transferred in a path-independent manner. In contrast, if a Riemannian manifold is not block-diagonalizable, there may be no solutions of Eqs.(16-18). For example, on any intrinsically curved two-dimensional surface (e.g., a sphere), it is not possible to find a one-dimensional projector at each point (i.e., a direction at each point) that satisfies Eq.(18). This is because the parallel transfer of directions on such a surface is path dependent.

Suppose we know that the metric can be transformed into the form in Eq.(8), and suppose we can find the corresponding solutions of Eqs.(16-18). Then, we can use them to explicitly construct a transformation from the data-defined coordinate system (\tilde{x}) to a block-diagonal coordinate system (s). Let Ã^{k}ₗ(\tilde{x}₀) and \tilde{B}^{k}ₗ(\tilde{x}₀) be the solutions of Eqs.(16-18) at an arbitrarily-chosen point \tilde{x}₀. The first step is to use these projectors to construct a geodesic coordinate system. To do this, first select n linearly independent small vectors δ\tilde{y}₍ᵢ₎ (i=1, 2, . . . , n) at \tilde{x}₀, and use Ã^{k}ₗ(\tilde{x}₀) and \tilde{B}^{k}ₗ(\tilde{x}₀) to project them onto the local A and B subspaces. Then, use the results to create a set of n_{A} linearly independent vectors δ\tilde{x}₍ₐ₎ (a=1, 2, . . . , n_{A}) and a set of n_{B} linearly independent vectors δ\tilde{x}_{(b)} (b=n_{A}+1, n_{A}+2, . . . , n), which lie within the A and B subspaces, respectively. Finally: 1) starting at \tilde{x}₀, use the affine connection to repeatedly parallel transfer all δ\tilde{x} along δ\tilde{x}₍₁₎; 2) starting at each point along the resulting geodesic path, repeatedly parallel transfer these vectors along δ\tilde{x}₍₂₎; . . . continue the parallel transfer process along the directions δ\tilde{x}₍₃₎ . . . δ\tilde{x}₍ₙ₋₁₎ . . . n) starting at each point along the most recently produced geodesic path, parallel transfer these vectors along δ\tilde{x}₍ₙ₎. Each point in the neighborhood of \tilde{x}₀ is assigned the geodesic coordinate s (sₖ, k=1, 2, . . . , n), where each component sₖ represents the number of parallel transfers of the vector δ\tilde{x}₍ₖ₎ that was required to reach it. If these projection and parallel transfer procedures are visualized in the x coordinate system, it can be seen that the first n_{A} components of s (i.e., s_{A}) will be functions of x_{A} and the last n_{B} components of s (s_{B}) will be functions of x_{B}. In other words, s and x will just differ by a coordinate transformation that is block-diagonal with respect to the subspaces. Therefore, the metric will be block-diagonal in the s coordinate system, just like it is in the x coordinate system. But, because s is defined by a coordinate-system-independent procedure, the same s coordinate system will be constructed by performing that procedure in the data-defined (\tilde{x}) coordinate system. In summary: Eq.(8) necessarily implies that there are subspace projectors satisfying Eqs.(16-18) at \tilde{x}₀ and that the metric will look like Eq.(8) in the geodesic (s) coordinate system computed from those projectors.

We are now in a position to systematically determine if the observed data can be decomposed into independent source variables. The first step is to use the observed measurements \tilde{x}₍ₜ₎ to compute the metric (Eq.(4)), affine connection (Eq.(14)), and curvature tensor (Eq.(13)) at an arbitrary point \tilde{x}₀ in the data space. Next, we look for projectors Ã^{k}ₗ(\tilde{x}₀) that are solutions of Eqs.(16-18) at that point. If a solution is not found, we conclude that the metric cannot be diagonalized into two or more blocks (i.e., there is only one irreducible block) and, therefore, the data are not separable. If one or more solutions are found, we search for one that leads to an s (geodesic) coordinate system in which the metric is block-diagonal everywhere. If there is no such solution (i.e., all the solutions are extraneous), we conclude that the metric has only one irreducible block, and, therefore, the data are not separable. If we do find such a solution, we use it to transform the metric into the form of Eq.(8), and the foregoing procedure is then applied separately to each block in order to see if it can be further block-diagonalized into smaller blocks. In this way, we construct a geodesic coordinate system (s) in which the metric consists of a diagonal array of irreducible blocks. The only other irreducibly block-diagonal coordinate systems are those produced by permutations of blocks, intrablock coordinate transformations, and possible isometrics of the metric that mix coordinate components from different blocks.

As mentioned before, each multidimensional source variable may be comprised of the coordinate components in one group of a set of mutually exclusive groups of blocks in an irreducibly block-diagonal coordinate system (or mixtures of the coordinate components within such a group of blocks). In most practical applications, the data-derived metric will have no isometries that mix coordinate components from different blocks. In that case, the above-described geodesic (s) coordinate system is the only possible separable coordinate system (up to the permutations and intrablock transformations). Then, the final step is to compute the density function of the data in the s coordinate system and determine if it is the product of two or more factors, each of which is a function of the components (and their time derivatives) in one group of a set of mutually exclusive groups of irreducible coordinate blocks. If it does factorize, the corresponding groups of coordinate components comprise multidimensional source variables that are unique (up to permutations and transformations of each multidimensional source variable). If it does not factorize, the data are not completely separable.

In the special case in which the metric does have isometries that mix coordinate components of different blocks, the factorizability of the density function may be tested in all coordinate systems derived by isometric transformations of the s coordinate system. Notice that this procedure will not produce a unique set of source variables if the density function factorizes in more than one of these isometrically-related coordinate systems. In practical applications, the most important case in which there are metric isometrics involves a metric that describes a multidimensional flat subspace. Specifically, suppose that the irreducible form of the metric includes n_{E} one-dimensional blocks, where n_{E}≧2. Because the metric is positive-definite and each diagonal element is a function of the corresponding coordinate component, each 1×1 metric block can be transformed to unity by a possibly nonlinear transformation of the corresponding variable. These components can then be mixed by any n_{E}-dimensional rotation, without affecting the metric (i.e., these rotations are isometries that mix the coordinate components of different one-dimensional blocks). For each value of this unknown rotation matrix, one must then determine if the density function factorizes. Thus, in this particular case, the proposed methodology reduces the nonlinear BSS problem to the linear BSS problem of finding which rotations of the data separate them.

In practice, we may not have enough data to accurately calculate the phase space density function and thereby directly assess the separability of the s coordinate system (and possible isometric transformations of it). However, in that case, we can still check a variety of weaker conditions that are necessary for separability. For example, we could compute σₖₗ (Eq.(6)) in order to see if it has a block-diagonal form, in which the blocks correspond to mutually exclusive groups of the irreducible metric blocks. Likewise, we could check higher-order correlations of s and s components in order to see if they factorize into products of lower-order correlations, which involve the variables within mutually exclusive groups of metric blocks. The only possible multidimensional source variables consist of the coordinate components in mutually exclusive groups of irreducible metric blocks for which these higher-order correlations are found to factorize.

Another method of block-diagonalizing the metric should be noted. The first step is to look for projectors that satisfy Eqs.(16-18) and that have a vanishing covariant derivative at points scattered throughout the data manifold. If there is no such solution, the metric is not block-diagonalizable. If a solution is found, it can be “spread” to other points by parallel transfer from the scattered points. Then, the complimentary projectors \tilde{B}^{k}ₗ=δ^{k}ₗ−Ã^{k}ₗ at those points can be used to create a family of “B” subspaces, each of which has n_{B}=n−n_{A} dimensions and each of which is projected onto itself by \tilde{B}^{k}ₗ (i.e., in the sense that, at each point in such a subspace, the local projector \tilde{B}^{k}ₗ projects all of the local vectors within the subspace onto themselves). For example, a B subspace can be constructed by starting at one of the projector points and identifying nearby points connected to the starting point by short line segments, each of which is projected onto itself by the projector \tilde{B}^{k}ₗ at the starting point. This procedure is then iterated by performing it at each of the identified nearby points, using an estimate of the projector \tilde{B}^{k}ₗ there. Finally, the B subspace is identified as the n_{B}-dimensional set of points containing the points in the identified line segments, together with points smoothly interpolated among them. The next step is to assign each of these subspaces a unique set of n_{A} numbers that define the s coordinate components sₖ (k=1, . . . , n_{A}) of every point in that subspace. The corresponding s coordinate components sₖ (k=1, . . . , n_{A}) of other points in the data space are defined by interpolation among the s coordinate components of nearby points within B subspaces. In a like manner, the projector A^{k}ₗ can be used to construct a family of A subspaces, each of which has n_{A} dimensions. Each of these subspaces is assigned a unique set of n_{B} numbers that define the s coordinate components sₖ (k=n_{A}+1, . . . , n) of every point in that subspace. The corresponding s coordinate components of other points in the data space are defined by interpolation among the s coordinate components of nearby points within A subspaces. The final step is to transform the metric into the s coordinate system that has been defined in this way. If the metric does not have a block-diagonal form, the above-described procedure is performed for other solutions of Eqs.(16-18). If there is no solution for which the metric has block-diagonal form, the metric is not block-diagonalizable. On the other hand, if a solution is found that leads to a block-diagonal metric, the above procedure can then be applied to the individual blocks in order to see if they can be split into smaller blocks. When each block cannot be split, the metric is in irreducibly block-diagonal form.

The procedure for block-diagonalizing the metric described in the preceding paragraph can be modified if: 1) it is known a priori that the data were produced by a set of two independent source systems (the A and B systems); 2) it is possible to identify a set of times (called the A times) at which the energy and/or information produced by the A system is being detected by the detectors used to create the input data, while the energy and/or information produced by the B system is not being detected by the detectors. The input data at the A times define an A subspace within the input data space, and, furthermore, the input data at the A times can be used to compute Ã^{k}ₗ projectors at multiple points within that A subspace. Specifically, at each of these points \tilde{x}, one computes a quantity Ã^{kl}(\tilde{x})=<( [symbol] − [symbol] )( [symbol] − [symbol] )>_{\tilde{x}}, where the time averages therein are performed over the input data in a neighborhood of x at the A times. Then, Ã^{k}ₗ(\tilde{x}) is set equal to Ã^{km}(\tilde{x})\tilde{g}ₘₗ(\tilde{x}) where \tilde{g}ₖₗ is the covariant metric. Next, the affine connection is used to compute Ã^{k}ₗ at points throughout the space of input data, by parallel transferring it from the locations within the A subspace, where it is known. Finally, \tilde{B}^{k}ₗ is computed at each of these points, and the procedure in the preceding paragraph is used to compute the families of A and B subspaces that define the transformation to a coordinate system in which the metric is composed of A and B blocks.

The procedure for finding source variables can also be expedited if the following prior knowledge is available: 1) the input data \tilde{x}(t) are known to have been produced by two independent source systems (the A and B systems); 2) the trajectories of two “prior” systems (PA and PB), which may or may not be physically identical to the source systems, are known to have phase space density functions equal to those of the A and B systems, if appropriate coordinate systems are used on the spaces of the data from the prior and source systems; 3) we know the “prior” data (x_{PA}(t) and x_{PB}(t)) corresponding to those trajectories. For example, this situation would arise if: 1) it is desired to separate the simultaneous utterances of two speakers (the A and B systems); 2) there are two “prior” speakers (PA and PB) whose density functions are approximately text-independent and whose style of speech “mimics” that of speakers A and B, in the sense that there is an invertible mapping between the input data from PA and A, when they speak the same words, and there is an invertible mapping between the input data from PB and B, when they speak the same words; 3) data corresponding to utterances of each prior speaker (PA and PB) have been recorded. In this case, the transformation between the \tilde{x} and x (source) coordinate systems on the space of input data can be determined in the following manner: 1) compute a set of scalar functions (denoted by \tilde{S}₍ₖ₎(\tilde{x}) for k=1, 2, . . . ) in the \tilde{x} coordinate system of the input data space by processing \tilde{x}(t) in such a way that the same functions would be constructed by processing any other set of input data having the same density function; 2) compute the analogous scalar functions S₍ₖ₎(x) in the x coordinate system of the prior data space by processing x_{P}(t)=(x_{PA}(t), x_{PB}(t)); 3) solve the equations \tilde{S}₍ₖ₎(\tilde{x})=S₍ₖ₎(x(\tilde{x})) to find x(\tilde{x}). This mapping must be the same as the mapping that is known to transform the density function of the input data into the density function of the prior data, Because the latter is factorizable, this is guaranteed to be the desired mapping to a source coordinate system.

The following is an example of a procedure that can be used to construct such a scalar function in the \tilde{x} coordinate system of the input data space: 1) use \tilde{x}(t) to compute a set of local tensor densities (possibly including those with weight equal to zero; i.e., including ordinary tensors) in the \tilde{x} coordinate system of the input data space, each of which has the property that the same tensor density would be constructed from any other set of input data having the same density function; 2) at some point \tilde{x}, specify a set of algebraic constraints on the components of these tensor densities such that: a) there is a non-empty set of other coordinate systems in which the constraints are satisfied and b) the value of a particular component of these tensor densities is the same in all of those other coordinate systems; 3) the value of this particular tensor density component defines the value of one of the scalar functions \tilde{S}₍ₖ₎(\tilde{x}) at point \tilde{x}. This method can be used to construct scalar functions from a list of tensor densities that includes the local average velocity of the input data [symbol] =< [symbol] >_{\tilde{x}}, the metric tensor (contravariant and covariant versions), higher order local velocity correlations including

<( [symbol] = [symbol] )( [symbol] − [symbol] )( [symbol] − [symbol] ) . . . >_{\dot{x}},

covariant derivatives of these tensor densities, and additional tensor densities created from algebraic combinations of the components of these tensor densities and their ordinary partial derivatives, such as the Riemann-Christoffel curvature tensor.

Another set of such scalar functions can be constructed by using the metric and affine connection derived from \tilde{x}(t) to compute the geodesic coordinates \tilde{s}ₖ(\tilde{x}) of each point x in the input data space (see Section I). Because of the coordinate-system-independent nature of parallel transfer, this procedure defines scalar functions, and, furthermore, these functions are the same as the functions that would be constructed from any other set of input data having the same density function. Therefore, we can use \tilde{S}₍ₖ₎(\tilde{x})=\tilde{s}ₖ(\tilde{x}) and, similarly, S₍ₖ₎(x)=sₖ(x), where the right side denotes the geodesic coordinates of point x in the prior data space, computed from the prior data x_{P}(t). In this construction, it was implicitly assumed that the geodesic coordinates in the x coordinate system are computed from transformed versions of the reference point (\tilde{x}₀) and reference vectors (δ\tilde{x}₍ᵢ₎) that were used in the \tilde{x} coordinate system. This can be arranged in the following manner: the above-described construction of scalars from algebraically-constrained tensors can be used to determine the coordinates of n+1 points in the \tilde{x} and x coordinate systems (\tilde{x}₍ᵢ₎ and x₍ᵢ₎ for i=0, 1, . . . n) that are related by x(\tilde{x}). These points can then be used to determine the \tilde{x} and x coordinates of the reference point and the reference vectors. For example, the coordinates of the reference point can be taken to be \tilde{x}₀=\tilde{x}₍₀₎ and x₀=x₍₀₎. In each coordinate system, each reference vector (represented by δ\tilde{x}₍ᵢ₎ and δx₍ᵢ₎ for i=1, . . . n) can be computed to be the small vector at the reference point, which can be parallel transferred along itself a predetermined number of times in order to create a geodesic connecting the reference point to one of the other n+1 points (represented by \tilde{x}₍ᵢ₎ and x₍ᵢ₎ in the two coordinate systems). The coordinate-system-independence of parallel transfer guarantees that the resulting quantities δ\tilde{x}₍ᵢ₎ and δx₍ᵢ₎ will be transformed versions of one another, as required.

The above-described methods of using prior data from prior systems can be modified if the prior data is known in a y coordinate system on the prior space, which is related by a known coordinate transformation x(y) to a source (x) coordinate system on the prior space. In that case, the transformation from the x coordinate system to the x (source) coordinate system on the input space is x(\tilde{x})=x(y(\tilde{x})), where y(\tilde{x}) can be determined by the above-described process of using the input data and the prior data to construct scalar functions on the input and prior spaces, respectively.

### II. Illustrative Examples

### II.A. Analytic Examples

In this subsection, we demonstrate large classes of trajectories that satisfy the assumptions in Section I. In these cases: 1) the trajectory's statistics are described by a density function in phase space; 2) the trajectory-derived metric is well-defined and can be computed analytically; 3) there is a source coordinate system in which the density function is separable into the product of two density functions. Many of these trajectories are constructed from the behavior of physical systems that could be realized in actual or simulated laboratory experiments (see Section II.C).

First, consider the energy of a physical process with n degrees of freedom x (xₖ for k=1, 2, . . . , n)

$$E ( x , \dot{x} ) = \frac{1}{2} {μ}_{kl} ( x ) {\dot{x}}_{k} {\dot{x}}_{l} + V ( x ) , \qquad ( Eq . 19 )$$

where μhd kl and V are some functions of x. Furthermore, suppose that

$$\begin{matrix}{μ}_{kl} ( x ) = {( \begin{matrix}{μ}_{A} ( {x}_{A} ) & 0 \\ 0 & {μ}_{B} ( {x}_{B} )\end{matrix} )}_{kl} , & ( Eq . 20 ) \\ V ( x ) = {V}_{A} ( {x}_{A} ) + {V}_{B} ( {x}_{B} ) , & ( Eq . 21 )\end{matrix}$$

where μ_{A} and μ_{B} are n_{A}×n_{A} and n_{B}×n_{B} matrices for 1≦n_{A}<n and n_{B}=n−n_{A}, where each 0 symbol denotes a null matrix of appropriate dimensions, and where x_{Ak}=xₖ for k=1, 2, . . . , n_{A} and x_{Bk}=xₖ for k=n_{A}+1, n_{A}+2, . . . , n. These equations describe the degrees of freedom (x_{A} and x_{B}) of almost any pair of classical physical systems, which do not exchange energy or interact with one another. A simple system of this kind consists of a particle with coordinates x_{A} moving in a potential V_{A} on a possibly warped two-dimensional frictionless surface with physical metric μ_{Akl}(x_{A}), together with a particle with coordinates x_{B} moving in a potential V_{B} on a two-dimensional frictionless surface with physical metric μ_{Bkl}(x_{B}). In the general case, suppose that the system intermittently exchanges energy with a thermal “bath” at temperature T. This means that the system evolves along one trajectory from the Maxwell-Boltzmann distribution at that temperature and periodically jumps to another trajectory randomly chosen from that distribution. After a sufficient number of jumps, the amount of time the system will have spent in a small neighborhood dxd\dot{x} of (x, \dot{x}) is given by the product of dxd\dot{x} and a density function that is proportional to the Maxwell-Boltzmann distribution

μ(x)exp [−E(x, \dot{x})/kT], (Eq. 22)

where k is the Boltzmann constant and μ is the determinant of μₖₗ. The existence of this density function means that the local velocity covariance matrix is well-defined, and computation of the relevant Gaussian integrals shows that it is

<(\dot{x}ₖ− [symbol] )(\dot{x}ₗ− [symbol] )>ₓ=kTμ^{kl}(x), (Eq. 23)

where μ^{kl} is the contravariant tensor equal to the inverse of μₖₗ. It follows that the trajectory-induced metric on the state space is well-defined and is given by gₖₗ(x)=μₖₗ(x)/kT. Furthermore, Eq.(22) shows that the density function is the product of the density functions of the two non-interacting subsystems.

Section II.C describes the numerical simulation of a physical system of this type, which was comprised of two non-interacting subsystems: one with two statistically dependent degrees of freedom and the other with one degree of freedom. The technique in Section I.B was applied to the observed data to perform multidimensional BSS: i.e., to blindly find the transformation from a data-defined coordinate system to a source coordinate system.

### II.B. Separating Simultaneous Synthetic “Utterances” Recorded with a Single Microphone

This section describes a numerical experiment in which two sounds were synthesized and then summed, as if they occurred simultaneously and were recorded with a single microphone. Each sound simulated an “utterance” of a vocal tract resembling a human vocal tract, except that it had fewer degrees of freedom (one degree of freedom instead of the 3-5 degrees of freedom of the human vocal tract). The methodology described in Section I.A was blindly applied to the synthetic recording, in order to recover the time dependence of the state variable of each vocal tract (up to an unknown transformation on each voice's state space). Each recovered state variable time series was then used to synthesize an acoustic waveform that sounded like a voice-converted version of the corresponding vocal tract's utterance.

The glottal waveforms of the two “voices” had different pitches (97 Hz and 205 Hz), and the “vocal tract” response of each voice was characterized by a damped sinusoid, whose amplitude, frequency, and damping were linear functions of that voice's state variable. For example, the resonant frequency of one voice's vocal tract varied linearly between 300-900 Hz as that voice's state variable varied on the interval [−1, +1]. For each voice, a ten hour utterance was produced by using glottal impulses to drive the vocal tract's response, which was determined by the time-dependent state variable of that vocal tract. The state variable time series of each voice was synthesized by smoothly interpolating among successive states randomly chosen at 100-120 msec intervals. The resulting utterances had energies differing by 0.7 dB, and they were summed and sampled at 16 kHz with 16-bit depth. Then, this “recorded” waveform was subjected to a short-term Fourier transform (using frames with 25 msec length and 5 msec spacing). The log energies of a bank of 20 mel-frequency filters between 0-8000 Hz were computed for each frame, and these were then averaged over each set of four consecutive frames. These log filterbank outputs were nonlinear functions of the two vocal tract state variables, which were statistically independent of each other.

The remainder of this section describes how these data were analyzed in a completely blind fashion in order to discover the presence of two underlying independent source variables and to recover their time courses. In other words, the filterbank outputs were processed as a time series of numbers of unknown origin, without using any of the information in the preceding paragraph. For example, the analysis did not make use of the fact that the data were produced by driven resonant systems.

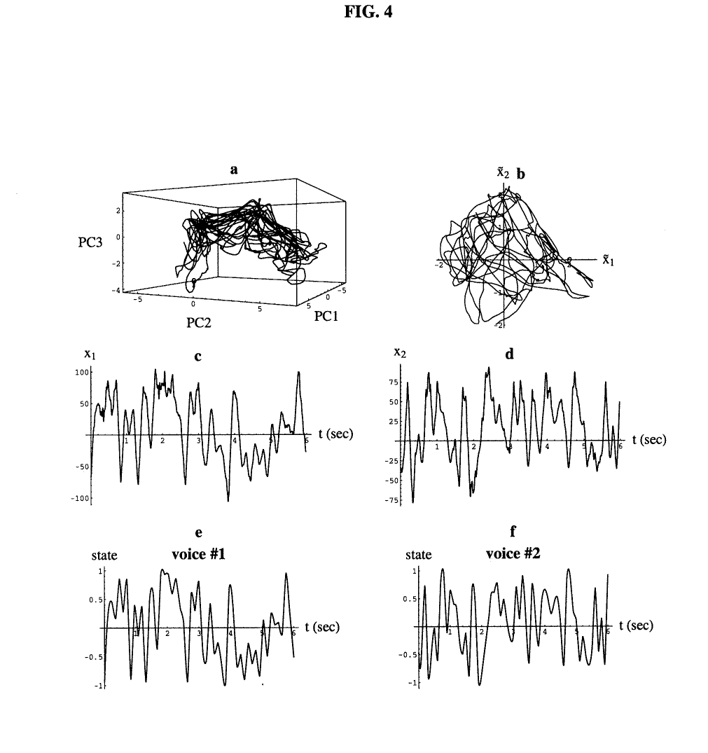

The first step was to determine if any data components were redundant in the sense that they were simply functions of other components. FIG. 4a shows the first three principal components of the data during a typical “recorded” segment of the simultaneous utterances. Inspection showed that these data lay on a two-dimensional surface within the ambient 20-D space, making it apparent that they were produced by an underlying system with two degrees of freedom. The redundant components were eliminated by using dimensional reduction to establish a coordinate system \tilde{x} (\tilde{x}ₖ for k=1, 2) on this surface and to find the trajectory of the recorded sound \tilde{x}(t) in that coordinate system (FIG. 4b). In effect, \tilde{x}(t) represents a relatively low bandwidth 2-D signal that was “hidden” within the higher bandwidth waveform recorded with the simulated microphone. The next step was to determine if the components of \tilde{x}(t) were nonlinear mixtures of two source variables that were statistically independent of one another, in the sense that they had a factorizable phase space density function. Following the procedure in Section I.A, \tilde{x}(t) of the entire recording was used to compute the metric in Eq.(4) on a 32×32 grid in \tilde{x}-space, and the result was differentiated to compute the affine connection and curvature tensor there. The values of the latter were distributed around zero, suggesting that the state space was flat (as in Eq.(5)), which is a necessary condition for the separability of the data. The procedure in Section I.A was then followed to transform the data into a Euclidean coordinate system s, and the resulting trajectory s(t) was substituted into Eq.(6) to compute the state variable correlation matrix. Finally, the rotation that diagonalized this matrix was used to rotate the s coordinate system, thereby producing the x coordinate system, which was the only possible separable coordinate system (up to transformations of individual components). FIGS. 4c-f show that the time courses of the putative source variables (x₁(t) and x₂(t)) were nearly the same as the time courses of the statistically independent state variables, which were used to generate the voices' utterances (up to a transformation on each state variable space). Thus, it is apparent that the information encoded in the time series of each vocal tract's state variable was blindly extracted from the simulated recording of the superposed utterances.

It is not hard to show that the same results will be obtained if we similarly process input data consisting of any set of five or more spectral features that are functions of the two underlying state variables. For any choice of such features, the system's trajectory in feature space will lie on a two-dimensional surface, on which a coordinate system \tilde{x} (\tilde{x}ₖ for k=1,2) can be induced by dimensional reduction. The Takens embedding theorem almost guarantees that there will be an invertible mapping between the values of \tilde{x} and the underlying state variables of the two vocal tracts. This means that \tilde{x} will constitute a coordinate system on the state space of the system, with the nature of that coordinate system being determined by the choice of the chosen spectral features. In other words, the only effect of measuring different spectral features is to influence the nature of the coordinate system in which the system's state space trajectory is observed. However, recall that the procedure for identifying source variables in Section I.A is coordinate-system-independent. Therefore, no matter what spectral features are measured, the same source variables will be identified (up to permutations and transformations of individual components).

It was not possible to use the single-microphone recording to recover the exact sound of each voice's utterance. However, the recovered state variable time series (e.g., FIGS. 4c-d) were used to synthesize sounds in which the original separate “messages” could be heard. Specifically, the above-derived mapping from filterbank-output space to x space was inverted and used to compute a trajectory in filterbank-output space, corresponding to the recovered x₁(t) (or x₂(t)) time series and a constant value of x₂ (or x₁). Then, this time series of filterbank outputs was used to compute a waveform that had similar filterbank outputs. In each case, the resulting waveform sounded like a crude voice-converted version of the original utterance of one voice, with a constant “hum” of the other voice in the background.

### II.C. Optical Imaging of Two Moving Particles

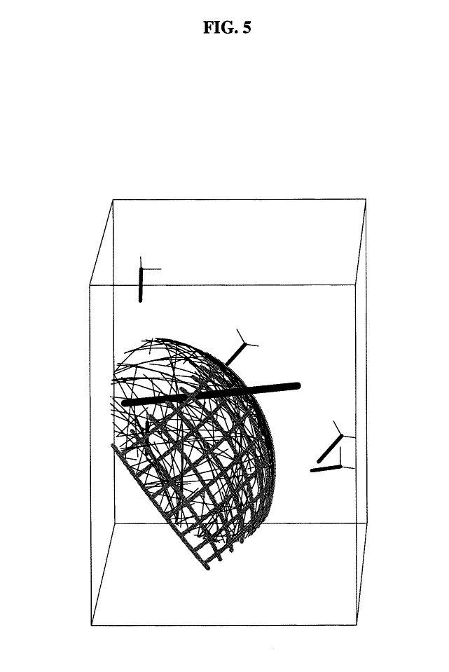

In the following, the scenario described in Section II.A is illustrated by the numerical simulation of a physical system with three degrees of freedom. The system was comprised of two moving particles of unit mass, one moving on a transparent frictionless curved surface and the other moving on a frictionless line. FIG. 5 shows the curved surface, which consisted of all points on a spherical surface within one radian of a randomly chosen point. FIG. 5 also shows that the curved surface and line were oriented at arbitrarily-chosen angles with respect to the simulated laboratory coordinate system. Both particles moved freely, and they were in thermal equilibrium with a bath for which kT=0.01 in the chosen units of mass, length, and time. As in Section II.A, the system's trajectory was created by temporally concatenating approximately 8.3 million short trajectory segments randomly chosen from the corresponding Maxwell-Boltzmann distribution, given by Eqs.(19-22) where x_{A} and x_{B} denote coordinates on the spherical surface and on the line, respectively, where μ_{A} is the metric of the spherical surface, where μ_{B} is a constant, and where V_{A}=V_{B}=0. The factorizability of this density function makes it evident that x=(x_{A}, x_{B}) comprised a source coordinate system. FIG. 5 shows a small sample of the trajectory segments.

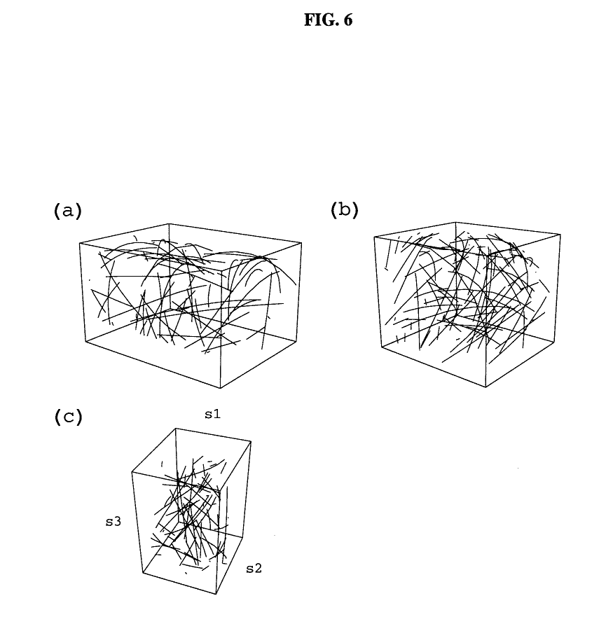

The particles were “watched” by a simulated observer Õb equipped with five pinhole cameras, which had arbitrarily chosen positions and faced the sphere/line with arbitrarily chosen orientations (FIG. 5). The image created by each camera was transformed by an arbitrarily chosen second-order polynomial, which varied from camera to camera. In other words, each pinhole camera image was warped by a translational shift, rotation, rescaling, skew, and quadratic deformation that simulated the effect of a distorted optical path between the particles and the camera's “focal” plane. The output of each camera was comprised of the four numbers representing the two particles' locations in the distorted image on its focal plane. As the particles moved, the cameras created a time series of detector outputs, each of which consisted of the 20 numbers produced by all five cameras at one time point. FIG. 6a shows the first three principal components of the system's trajectory through the corresponding 20-dimensional space. A dimensional reduction technique was applied to the full 20-dimensional time series in order to identify the underlying three-dimensional measurement space and to establish a coordinate system (\tilde{x}) on it, thereby eliminating redundant sensor data. FIG. 6b shows typical trajectory segments in the \tilde{x} coordinate system. Because the underlying state space had dimensionality n=3 and because the 20-dimensional detector outputs had more than 2n components, the Takens embedding theorem virtually guaranteed that there was a one-to-one mapping between the system states and the corresponding values of \tilde{x}. In other words, it guaranteed that the \tilde{x} coordinates were invertible instantaneous mixtures of the particle locations, as in Eq.(1). The exact nature of the mixing function depended on the positions, orientations, and optical distortions of the five cameras.

Given the measurements \tilde{x}(t) and no other information, our task was to determine if they were instantaneous mixtures of statistically independent groups of source variables. This was accomplished by blindly processing the data with the technique described in Section I.B. First, Eqs.(4) and (13)-(14) were used to compute the metric, affine connection, and curvature tensor in this coordinate system. Then, Eqs.(16-18) were solved at a point \tilde{x}₀. One pair of solutions was found, representing a local projector onto a two-dimensional subspace and the complementary projector onto a one-dimensional subspace. Following the procedure in Section I.B, we selected three small linearly independent vectors δ\tilde{y}₍ᵢ₎ (i=1, 2, 3) at \tilde{x}₀, and we used the projectors at that point to project them onto the putative A and B subspaces. Then, the resulting projections were used to create a set of two linearly independent vectors δ\tilde{x}₍ₐ₎ (a=1, 2) and a single vector δ\tilde{x}₍₃₎ within the A and B subspaces, respectively. Finally, the geodesic (s) coordinate system was constructed by using the affine connection to parallel transfer these vectors throughout the neighborhood of \tilde{x}₀ (FIG. 6c). After the metric was transformed into the s coordinate system, it was found to have a nearly block-diagonal form, consisting of a 2×2 block and a 1×1 block. Because the two-dimensional subspace had non-zero intrinsic curvature, the 2×2 metric block could not be decomposed into smaller (i.e., one-dimensional) blocks. Therefore, in this example, the only possible source coordinate system was the geodesic (s) coordinate system, which was unique up to coordinate transformations on each block and up to subspace permutations.

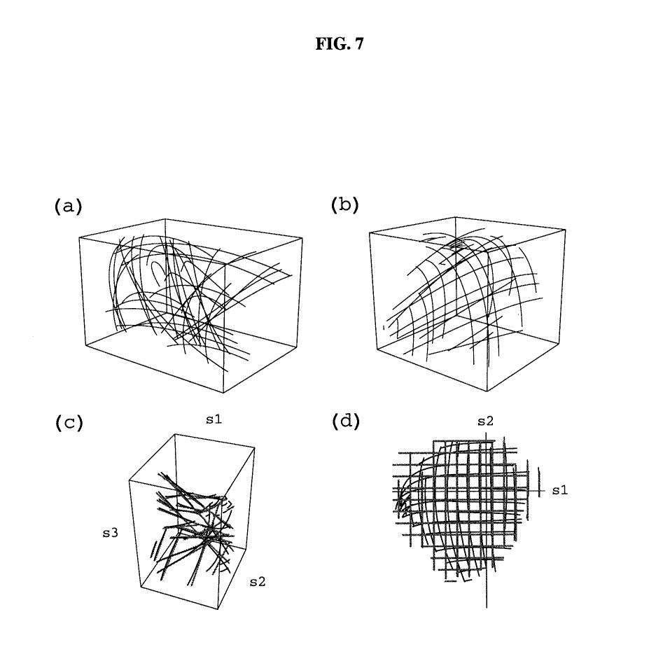

In order to demonstrate the accuracy of the above separation process, we defined “test lines” that had known projections onto the independent subspaces used to define the system. Then, we compared those projections with the test pattern's projection onto the independent subspaces that were “experimentally” determined as described above. First, we defined an x coordinate system in which x_{A} was the position (longitude, latitude) of the particle on the spherical surface and in which x_{B} was the position of the other particle along the line (FIG. 5). In this coordinate system, the test lines consisted of straight lines that were oriented at various angles with respect to the x_{B}=0 plane and that projected onto the grid-like array of latitudes and longitudes in that plane. In other words, each line corresponded to a path generated by moving the first particle along a latitude or longitude of the sphere and simultaneously moving the second particle along its constraining line. The points along these test lines were “observed” by the five pinhole cameras to produce corresponding lines in the 20-dimensional space of the cameras' output (FIG. 7a). These lines were then mapped onto lines in the \tilde{x} coordinate system by means of the same procedure used to dimensionally reduce the trajectory data (FIG. 7b). Finally, the test pattern was transformed from the \tilde{x} coordinate system to the s coordinate system, the geodesic coordinate system that comprised the “experimentally” derived source coordinate system. As mentioned above, the s coordinate system was the only possible separable coordinate system, except for permutations and arbitrary coordinate transformations on each subspace. Therefore, it should be the same as the x coordinate system (an exactly known source coordinate system), except for such transformations. The nature of that coordinate transformation depended on the choice of vectors that were parallel transferred to define the geodesic (s) coordinate system on each subspace. In order to compare the test pattern in the “experimentally” derived source coordinate system (s) with the appearance of the test pattern in the exactly known source coordinate system (x), we picked \tilde{x}₀ and the δ\tilde{y} vectors so that the s and x coordinate systems would be the same, as long as the independent subspaces were correctly identified by the BSS procedure. Specifically: 1) \tilde{x}₀ was chosen to be the mapping of the origin of the x coordinate system, which was located on the sphere's equator and at the line's center; 2) δ\tilde{y}₍₁₎ and δ\tilde{y}₍₂₎ were chosen to be mappings of vectors projecting along the equator and the longitude, respectively, at that point; 3) all three δ\tilde{x} were normalized with respect to the metric in the same way as the corresponding unit vectors in the x coordinate system. FIG. 7c shows that the test pattern in the “experimentally” derived source coordinate system consisted of nearly straight lines (narrow black lines), which almost coincided with the test pattern in the exactly known source coordinate system (thick gray lines). FIG. 7d shows that the test pattern projected onto a grid-like pattern of lines (narrow black lines) on the “experimentally” determined A subspace, and these lines nearly coincided with the test pattern's projection onto the exactly known A subspace (thick gray lines). These results indicate that the proposed BSS method correctly determined the source coordinate system. In other words, the “blind” observer Õb was able to separate the state space into two independent subspaces, which were nearly the same as the independent subspaces used to define the system.

### III. Discussion

As described in Section I.A, this disclosure teaches a procedure for performing nonlinear one-dimensional BSS, based on a notion of statistical independence that is characteristic of a wide variety of classical non-interacting physical systems. Specifically, this disclosure determines if the observed data are mixtures of source variables that are statistically independent in the sense that their phase space density function equals the product of density functions of individual components (and their time derivatives). In other words, given a data time series in an input coordinate system (\tilde{x}), this disclosure determines if there is another coordinate system (a source coordinate system x) in which the density function is factorizable. The existence (or non-existence) of such a source coordinate system is a coordinate-system-independent property of the data time series (i.e., an intrinsic or “inner” property). This is because, in all coordinate systems, there either is or is not a transformation to such a source coordinate system. In general, differential geometry provides mathematical machinery for determining whether a manifold has a coordinate-system-independent property like this. In the case at hand, we induce a geometric structure on the state space by identifying its metric with the local second-order correlation matrix of the data's velocity. Then, a necessary condition for BSS is that the curvature tensor vanishes in all coordinate systems (including the data-defined coordinate system). Therefore, if this data-derived quantity is non-vanishing, the data are not separable into one-dimensional source variables. However, if the curvature tensor is zero, the data are separable if and only if the density function is seen to factorize in a Euclidean coordinate system that can be explicitly constructed by using the data-derived affine connection. If it does factorize, these coordinates are the unique source variables (up to transformations that do not affect separability). In effect, the BSS problem requires that one sift through all possible mixing functions in order to find one that separates the data, and this arduous task can be mapped onto the solved differential geometric problem of examining all possible coordinate transformations in order to find one that transforms a flat metric into the identity matrix.

As described in Section I.B, this disclosure also teaches the solution of the more general multidimensional BSS problem, which is sometimes called multidimensional ICA or independent subspace analysis. Here, the source components are only required to be partitioned into statistically independent groups, each of which may contain statistically dependent components. This more general methodology is illustrated with analytic examples, as well as with the detailed numerical simulation of an optical experiment, in Sections II.A and II.C, respectively. Note that many of the most interesting natural signals (e.g., speech, music, electroencephalographic data, and magnetoencephalographic data) are likely to be generated by multidimensional sources. Therefore, multidimensional blind source separation will be necessary in order to separate those sources from noise and from one another.

In the preceding Sections, we implicitly sought to determine whether or not the data were separable everywhere (i.e., globally) in state space. However, this was done by determining whether or not local criteria for statistical independence (e.g., Eqs.(5) and (16-18)) were true globally. However, these local criteria could also be applied separately in each small neighborhood of state space in order to determine the degree of separability of the data in that “patch”. In this way, one might find that given data are inseparable in some neighborhoods, separable into multidimensional source variables in other neighborhoods, and separable into one-dimensional sources elsewhere. In other words, the system of this disclosure can be used to explore the local separability of data in the same way that Riemannian geometry can be used to assess the local intrinsic geometry of a manifold.

What are the limitations on the application of this disclosure? As discussed in Section I.A, the metric certainly exists if the trajectory is described by a density function in phase space, and, in Section II.A, we showed that this condition is satisfied by trajectories describing a wide variety of physical systems. More generally, the metric is expected to be well-defined if the data's trajectory densely covers a region of state space and if its local velocity distribution varies smoothly over that region. In practice, one must have observations that cover state space densely enough in order to determine the metric, as well as its first and second derivatives (required to compute the affine connection and curvature tensor). In the numerical simulation in Section II.C, approximately 8.3 million short trajectory segments (containing a total of 56 million points) were used to compute the metric and curvature tensor on a 32×32×32 grid on the three-dimensional state space. Of course, if the dimensionality of the state space is higher, even more data will be needed. So, a relatively long time series of data must be recorded in order to be able to separate them. However, this requirement isn't surprising. After all, our task is to examine the huge search space of all possible mixing functions, and the data must be sufficiently abundant and sufficiently restrictive to eliminate all but one of them. There are few other limitations on the applicability of the invention. In particular, computational expense is not prohibitive. The computation of the metric is the most CPU-intensive part of the method. However, because the metric computation is local in state space, it can be distributed over multiple processors, each of which computes the metric in a small neighborhood. The observed data can also be divided into “chunks” corresponding to different time intervals, each of which is sent to a different processor where its contribution to the metric is computed. As additional data are accumulated, it can be processed separately and then added into the time average of the data that were used to compute the earlier estimate of the metric. Thus, the earlier data need not be processed again, and only the latest observations need to be kept in memory.

As mentioned above, separability is an intrinsic property of a time series of data in the sense that it does not depend on the coordinate system in which the data are represented. However, there are many other intrinsic properties of such a time series that can be learned by a “blinded” observer. For instance, the data-derived parallel transfer operation can be employed to describe relative locations of the observed data points in a coordinate-system-independent manner. As a specific example of such a description, suppose that states \tilde{x}_{A}, \tilde{x}_{B}, and \tilde{x}_{C} differ by small state transformations, and suppose that a more distant state \tilde{x}_{D} can be described as being related to \tilde{x}_{A}, \tilde{x}_{B}, and \tilde{x}_{C} by the following procedure: “\tilde{x}_{D} is the state that is produced by the following sequence of operations: 1) start with state \tilde{x}_{A} and parallel transfer the vectors \tilde{x}_{B}−\tilde{x}_{A} and \tilde{x}_{C}−\tilde{x}_{A} along \tilde{x}_{B}−\tilde{x}_{A} 23 times; 2) start at the end of the resulting geodesic and parallel transfer \tilde{x}_{C}−\tilde{x}_{A} along itself 72 times”. Because the parallel transfer operation is coordinate-system-independent, this statement is a coordinate-system-independent description of the relative locations of \tilde{x}_{A}, \tilde{x}_{B}, \tilde{x}_{C}, and \tilde{x}_{D}. The collection of all such statements about relative state locations constitutes a rich coordinate-system-independent representation of the data. Such statements are also observer-independent because the only essential difference between observers equipped with different sensors is that they record the data in different coordinate systems (e.g., see the discussion in Section II.B). Different observers can use this technology to represent the data in the same way, even though they do not communicate with one another, have no prior knowledge of the observed physical system, and are “blinded” to the nature of their own sensors. FIGS. 7c-d demonstrate an example of this observer-independence of statements about the relative locations of data points. Specifically, these figures show how many parallel transfers of the vectors δ\tilde{x}₍ᵢ₎ were required to reach each point of the test pattern, as computed by an observer Õb equipped with five pinhole camera sensors (narrow black lines) and as computed by a different observer Ob, who directly sensed the values of x (thick gray lines). The current paper shows how such “blinded” observers can glean another intrinsic property of the data, namely its separability.

It is interesting to speculate about the relationship of the proposed methodology to biological phenomena. Many psychological experiments suggest that human perception is remarkably sensor-independent. Specifically, suppose that an individual's visual sensors are changed by having the subject wear goggles that distort and/or invert the observed scene. Then, after a sufficiently long period of adaptation, most subjects perceive the world in approximately the same way as they did before the experiment. An equally remarkable phenomenon is the approximate universality of human perception: i.e., the fact that perceptions seem to be shared by individuals with different sensors (e.g., different ocular anatomy and different microscopic brain anatomy), as long as they have been exposed to similar stimuli in the past. Thus, many human perceptions seem to represent properties that are “intrinsic” to the time series of experienced stimuli in the sense that they don't depend on the type of sensors used to observe the stimuli (or on the nature of the sensor-defined coordinate system on state space). In many situations, people are also able to perform source separation in a blinded or nearly blinded fashion. For example, they can often separate a speech signal from complex superposed noise (i.e., they can “solve the cocktail party problem”). This means that the human brain perceives another coordinate-system-independent property of the data, namely its separability. This disclosure provides a method of finding such “inner” properties of a sufficiently dense data time series. Is it possible that the human brain somehow extracts these particular geometric invariants from sensory data? The only way to test this speculation is to perform biological experiments to determine if the brain actually utilizes the specific data-derived metric and geometric structure described herein.

### IV. Examples of Applications

In practical situations, one often uses detectors to simultaneously observe two or more independent source systems, and it is desired to use the detector outputs to learn aspects of the evolution of individual source systems. Examples of such source systems include biological systems, inorganic systems, man-made systems including machines, non-man-made systems, or economic systems including business and market systems. Such systems may produce energy that includes electromagnetic energy, electrical energy, acoustic energy, mechanical energy, and thermal energy, and/or they may produce information, such as digital information about the status of an economic entity (including an economic entity's price, an economic entity's value, an economic entity's rate of return on investment, an economic entity's profit, an economic entity's revenue, an economic entity's cash flow, an economic entity's expenses, an economic entity's debt level, an interest rate, an inflation rate, an employment level, an unemployment level, a confidence level, an agricultural datum, a weather datum, and a natural resource datum). The energy produced by the source systems may be detected by a wide variety of detectors, including radio antenna, microwave antenna, infrared camera, optical camera, ultra-violet detector, X-ray detector, electrical voltage detector, electrical current detector, electrical power detector, microphone, hydrophone, pressure transducer, seismic activity detector, density measurement device, translational position detector, angular position detector, translational motion detector, angular motion detector, and temperature detector. The information produced by the source systems may be detected by a computer that receives such information through a communication link, such as a network, or through an attached memory storage device. It may be convenient to process the detector outputs in order to produce input data by a variety of methods, including a linear procedure, nonlinear procedure, filtering procedure, convolution procedure, Fourier transformation procedure, procedure of decomposition along basis functions, wavelet analysis procedure, dimensional reduction procedure, parameterization procedure, and procedure for rescaling time in one of a linear and nonlinear manner. Prior data from prior systems may also be available in embodiments of this disclosure, as described in Section I.B. Such prior systems may include systems sharing one or more characteristics of the above-described source systems, and such prior data may share one or more characteristics of the above-described input data. As described in Section III, the system of this disclosure can be used to process a wide variety of such input data in order to determine if those data are separable into statistically independent source variables (one-dimensional or multidimensional) and, if they are found to be separable, to compute the mixing function that relates the values of the data in the input coordinate system and the source coordinate system. After input data are transformed into the source coordinate system, they may provide information about individual source systems. At least one of the aforementioned steps may be performed by a computer hardware circuit, said circuit having an architecture selected from the group including a serial architecture, parallel architecture, and neural network architecture. Furthermore, at least one of the aforementioned steps may performed by a computer hardware circuit performing the computations of a software program, said software program having an architecture selected from the group including a serial architecture, parallel architecture, and neural network architecture.

A few examples of applications according to this disclosure are listed in the following:

1. Speech Recognition in the Presence of Noise
Suppose a speaker of interest is speaking in the presence of one or more independent “noise” systems (e.g., one or more other speakers or other systems producing acoustic waves). One or more microphones may be used to detect the acoustic waves produced by these source systems. In addition, the source systems may be monitored by video cameras and/or other detectors. The outputs of these detectors can be processed in order to produce input data that contain a mixture of information about the states of all of the source systems (e.g., see the example in Section II.B). After the system of this disclosure has been used to transform the input data to the source coordinate system, unmixed information about the utterances of the speaker of interest can be derived from the time dependence of a subset of source components. For instance, the time-dependent source components of interest can be used as the input of a speech recognition engine that identifies the corresponding words uttered by the speaker of interest. Alternatively, the time-dependent source components of interest can be used to synthesize utterances that a human can use to recognize the words uttered by the speaker of interest (e.g., see the example in Section II.B).

2. Separation of an Electromagnetic Signal from Noise
Suppose an electromagnetic signal from a source system of interest is contaminated by an electromagnetic signal from an independent “noise” system. For example, the signal of interest may be a particular cell phone signal and the “noise” signal may be the signal from another cell phone transmitter or from some other transmitter of electromagnetic radiation. The electromagnetic signals from these sources may be detected by one or more antennas, and the outputs of those antennas may be processed to produce input data that contain a mixture of the information from all of the sources. After the system of this disclosure has been used to transform the input data to the source coordinate system, unmixed information transmitted by the source of interest can be derived from the time dependence of a subset of source components. For example, the source components of interest might be used to recognize the words or data transmitted by the source of interest or to synthesize a signal that similar to the unmixed signal of interest.

3. Analysis of Electroencephalographic (EEG) Signals and Magnetoencephalographic (MEG) Signals
In many cases, EEG (or MEG) machines simultaneously detect energy from a neural process of interest and from other interfering processes. For example, the neural process of interest may be evolving in the language, motor, sensory and/or cognitive areas of the brain. Interfering processes may include neural processes regulating breathing (and/or other physiological functions), processes in other organs (e.g., the heart), and extracorporeal processes. This energy may be detected by electrical voltage detectors, electrical current detectors, and/or magnetic field detectors, and the outputs of these detectors may be processed to produce input data that contain a mixture of the information from all of these sources. After the present invention has been used to transform the input data to the source coordinate system, unmixed information about the neural process of interest can be derived from the time dependence of a subset of source components. For example, the source components of interest might be used to monitor the activities of the language, motor, sensory, and/or cognitive areas of the brain.

4. Analysis of Economic Information
There are numerous time-dependent data that can be used to monitor various economic activities: prices and return on investment of assets (e.g., stocks, bonds, derivatives, commodities, currencies, etc.), indices of performance of companies and other economic entities (e.g., revenue, profit, return on investment, cash flow, expenses, debt level, market share, etc.), and indicators of important economic factors (e.g., interest rates, inflation rates, employment and unemployment levels, confidence levels, agricultural data, weather data, natural resource data, etc.). This information can be received from various information providers by means of computer networks and memory storage media. A number of these data may be processed to produce input data that contain a mixture of information about known or unknown underlying economic determinants. After the present invention has been used to find the transformation from the input data to the source coordinate system, that transformation can be used to determine the nature of the statistical dependence of the input data components. This information can be used to determine the pricing, risk, rate of return, and other characteristics of various assets, and these determinations can be used to guide the trading of those assets. Furthermore, this information can be used to design new financial instruments (e.g., derivatives) that have desirable properties (e.g., high rate of return and low risk).

The systems may include additional or different logic and may be implemented in many different ways. A controller may be implemented as a microprocessor, microcontroller, application specific integrated circuit (ASIC), discrete logic, or a combination of other types of circuits or logic. Similarly, memories may be DRAM, SRAM, Flash, or other types of memory. Parameters (e.g., conditions and thresholds) and other data structures may be separately stored and managed, may be incorporated into a single memory or database, or may be logically and physically organized in many different ways. Programs and instruction sets may be parts of a single program, separate programs, or distributed across several memories and processors. The systems may be included in a wide variety of electronic devices, including a cellular phone, a headset, a hands-free set, a speakerphone, communication interface, or an infotainment system.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

What is claimed is:

1. A method of processing time-dependent input data obtained from at least two independently evolving source systems, the method comprising:
a) selecting said source systems;
b) obtaining time-dependent input data from said source systems, each said input datum at each time including n numbers, n being a positive integer, each said input datum at each time being a point in the input space of all possible input data, and the n numbers of each input datum being the coordinates of said point in the \tilde{x} coordinate system of said input space;
c) selecting input locations in said input space;
d) determining selected input data to be a subset of said input data, each datum in said subset being near said input locations and each datum in said subset being selected at one of a group of predetermined times;
e) processing said input data to determine a coordinate transformation from said x coordinate system on the input space near said input locations to an x coordinate system on the input space near said input locations, said x coordinate system having the property that the duration of time for which said selected input data in the x coordinate system are within a neighborhood of the point x having components xₖ (k=1, . . . , n) and the time derivatives of said selected input data are within a neighborhood of the point \dot{x} having components \dot{x}ₖ (k=1, . . . , n) is approximately equal to the product of the total time duration of said selected input data and ρ(x, \dot{x})dxd\dot{x}, dx being the volume of said neighborhood of said point x, d\dot{x} being the volume of said neighborhood of said point \dot{x}, ρ(x, \dot{x}) being approximately equal to the product of at least two factors, each said factor being a function of a subset of said components xₖ and the time derivatives of the components in said subset, and the components in said subset corresponding to one said factor not belonging to said subset of components corresponding to any other said factor;
f) transforming at least a portion of said selected input data from said \tilde{x} coordinate system to said x coordinate system on said input space; and
g) determining information about a group of at least one source system by processing a predetermined set of coordinate components of said portion of said selected input data in said x coordinate system, said predetermined set of coordinate components including at least one said subset of components.

2. The method according to claim 1 wherein the set of said input locations is selected from a group including a set of locations that are near all of the input data and a set of locations that are near a predetermined subset of the input data.

3. The method according to claim 1 wherein said information about a group of at least one source system includes the relative locations of data points in said portion of the selected input data, said relative locations being locations in a source system space, said relative locations being determined by:
a) transforming said selected input data near said input locations from the \tilde{x} coordinate system to the x coordinate system on said input space;
b) determining said source system space to be the space of all possible values of said predetermined set of coordinate components of said selected input data;
c) determining the source system data on said source system space to be said predetermined coordinate components of said transformed selected input data;
d) processing said source system data in order to determine the metric g_{A}^{kl} on said source system space, g_{A}^{kl} at point x_{A} in said source system space being approximately determined by
g_{A}^{kl}(x_{A})=<(\dot{x}_{Ak}− [symbol] )(\dot{x}_{Al}− [symbol] )>ₓ_{_{A}},
x_{A}(t) being said source system data at time t, x_{Ak} being the k^{th} component of x_{A}(t), \dot{x}_{A} being the time derivative of x_{A}(t), [symbol] being the time average of \dot{x}_{A} over said source system data in a predetermined neighborhood of said point x_{A}, the angular brackets denoting the time average of the bracketed quantity over the source system data in a predetermined neighborhood of said point x_{A}, k and l being integers in the range 1≦k, l≦n_{A}, and n_{A} being the number of coordinate components in said predetermined set of coordinate components; and
e) processing said source system data and said metric g_{A}^{kl} on said source system space to determine the relative location of a datum in said portion of the selected input data, said relative location being the relative location in said source system space of the coordinate components of said datum in said predetermined set of coordinate components.

4. The method according to claim 3 wherein the relative location of a predetermined destination point in said source system space relative to predetermined other points in said source system space is determined by:
a) determining a group of line segments in said source system space at an origin point in said source system space, said origin point being a predetermined one of said other points and said line segments including at least one line segment connecting said origin point to a nearby said other point in said source system space;
b) processing said metric g_{A}^{kl} on said source system space to determine a parallel transfer operation on said source system space, said parallel transfer of a vector V at point x_{A} in said source system space along a line segment δx_{A} in said source system space producing the vector V+δV at point x_{A}+δx_{A} in said source system space, δV being
δV^{k}=−Γ_{Alm}^{k}(x_{A})V^{l}δx_{Am},
δV^{k} being the k^{th} component of δV, V^{k} being the k^{th} component of V, δx_{Ak} being the k^{th} component of δx_{A}, Γ_{Alm}^{k}(x_{A}) being approximately determined by
$${Γ}_{Alm}^{k} ( {x}_{A} ) = \frac{1}{2} {g}_{A}^{ki} ( \frac{\partial {g}_{Ail}}{\partial {x}_{Am}} + \frac{\partial {g}_{Aim}}{\partial {x}_{Al}} - \frac{\partial {g}_{Alm}}{\partial {x}_{Ai}} ) ,$$
g_{Akl} being the matrix inverse of g_{A}^{kl}, all quantities being evaluated at location x_{A}, k, l, and m being integers in the range 1≦k, l, m≦n_{A}, n_{A} being the number of coordinate components in said predetermined set of coordinate components, and repeated indices being summed from 1 to n_{A};
c) determining a procedure for creating a path through said source system space from said origin point to said destination point, said path being determined by a series of said parallel transfer operations, each said parallel transfer operation moving at least one line segment in said source system space along another line segment in said source system space, and said at least one line segment and said another line segment being selected from a group including predetermined linear combinations of the line segments in said group of line segments at said origin point and predetermined linear combinations of the line segments in another group of line segments determined by parallel transfer of the line segments in said group of line segments at said origin point; and
d) determining the relative location of said destination point relative to said other points to be given by the description of said procedure for creating said path.

5. A method of processing time-dependent input data obtained from at least two independently evolving source systems, the method comprising:
a) selecting said source systems;
b) obtaining time-dependent input data from said source systems, each said input datum at each time including n numbers, n being a positive integer, each said input datum at each time being a point in the input space of all possible input data, and the n numbers of each input datum being the coordinates of said point in the \tilde{x} coordinate system of said input space;
c) selecting input locations in said input space;
d) determining selected input data to be a subset of said input data, each datum in said subset being near said input locations and each datum in said subset being selected at one of a group of predetermined times;
e) processing said selected input data in order to determine the metric \tilde{g}^{kl} in said \tilde{x} coordinate system at each point \tilde{x} near said input locations, \tilde{g}^{kl} at location \tilde{x} being approximately determined by
\tilde{g}^{kl}(\tilde{x})=<( [symbol] − [symbol] )( [symbol] − [symbol] )>_{\tilde{x}},
\tilde{x}(t) being the selected input data at time t, \tilde{x}ₖ being the k^{th} component of \tilde{x}(t), [symbol] being the time derivative of \tilde{x}(t), [symbol] being the time average of [symbol] over the selected input data in a predetermined neighborhood of said location \tilde{x}, the angular brackets denoting the time average of the bracketed quantity over the selected input data in a predetermined neighborhood of said location \tilde{x}, and k and l being integers in the range 1≦k, l≦n;
f) processing said input data and the determined metric to determine a coordinate transformation from said \tilde{x} coordinate system on said input space near said input locations to an s coordinate system on said input space near said input locations, said s coordinate system having the property that said metric in the s coordinate system has an approximately block-diagonal form, the configuration of said block-diagonal form being the same at all points \tilde{x} near said input locations and said block-diagonal form containing at least two blocks;
g) processing said input data in said s coordinate system and said determined metric in said s coordinate system to determine an isometric coordinate transformation from the s coordinate system to an x coordinate system on said input space near said input locations, said x coordinate system having the properties that said metric in said x coordinate system has approximately the same functional form as said metric in said s coordinate system and that the duration of time for which said selected input data in the x coordinate system are within a neighborhood of the point x having components xₖ (k=1, . . . , n) and the time derivatives of said selected input data are within a neighborhood of the point \dot{x} having components \dot{x}ₖ (k=1, . . . , n) is approximately equal to the product of the total time duration of the selected input data and ρ(x, x)dxd\dot{x}, dx being the volume of said neighborhood of said point x, d\dot{x} being the volume of said neighborhood of said point \dot{x}, ρ(x, \dot{x}) being approximately equal to the product of at least two factors, each said factor being a function of a subset of said components xₖ and the time derivatives of the components in said subset, and the components in said subset corresponding to one said factor not belonging to said subset of components corresponding to any other said factor;
h) transforming at least a portion of said selected input data from said \tilde{x}coordinate system to said x coordinate system on said input space; and
i) determining information about a group of at least one source system by processing a predetermined set of coordinate components of said portion of said selected input data in said x coordinate system, said predetermined set of coordinate components including at least one said subset of components.

6. The method according to claim 5 wherein the set of said input locations is selected from a group including a set of locations that are near all of the input data and a set of locations that are near a predetermined subset of the input data.

7. The method according to claim 5 wherein said coordinate transformation from said \tilde{x} coordinate system to said s coordinate system is calculated by determining an ordered series of at least one serial coordinate system on the input space, each said serial coordinate system being related to the preceding said serial coordinate system in said ordered series by one of an ordered series of serial coordinate transformations, further including:
a) determining the first serial coordinate system to be said \tilde{x} coordinate system;
b) processing said input data in said first serial coordinate system and said determined metric in said first serial coordinate system to determine a first serial coordinate transformation from the first serial coordinate system to a second serial coordinate system on the input space near said input locations, said first serial coordinate transformation having the property that said metric in said second serial coordinate system has an approximately block-diagonal form, the configuration of said block-diagonal form being the same at all locations near said input locations and said block-diagonal form containing at least two blocks;
c) processing said input data in a preceding serial coordinate system and said determined metric in said preceding serial coordinate system to determine a next serial coordinate transformation from the preceding serial coordinate system to a next serial coordinate system on the input space near said input locations, said next serial coordinate transformation having the property that said metric in said next serial coordinate system has an approximately block-diagonal form, the configuration of said block-diagonal form being the same at all points near said input locations and the number of blocks in said block-diagonal form being greater than the number of blocks in the block-diagonal form of said metric in the preceding serial coordinate system;
d) repeating step (c) until said processing to determine a next serial coordinate transformation does not produce a next serial coordinate transformation having the property that said metric in said next serial coordinate system has an approximately block-diagonal form with the number of blocks in said block-diagonal form being greater than the number of blocks in the block-diagonal form of said metric in the preceding serial coordinate system;
e) determining said s coordinate system to be the last serial coordinate system in said ordered series of serial coordinate systems; and
f) determining said coordinate transformation from said \tilde{x} coordinate system to said s coordinate system to be the coordinate transformation produced by compositing the serial coordinate transformations in said ordered series of serial coordinate transformations.

8. The method according to claim 5 wherein said coordinate transformation from said \tilde{x} coordinate system to said s coordinate system on said input space near said input locations is determined by:
a) determining a reference point \tilde{x}₀ in the input space, said reference point \tilde{x}₀ being determined by processing said input data and said determined metric;
b) determining n linearly independent local vectors δ\tilde{x}₍ᵢ₎ (i=1, . . . , n) at \tilde{x}₀, said local vectors δ\tilde{x}₍ᵢ₎ being determined by processing said input data and said determined metric;
c) starting at \tilde{x}₀ and repeatedly parallel transferring the δ\tilde{x}₍ᵢ₎ for i=1, . . . , n along δ\tilde{x}₍₁₎, said parallel transfer being a procedure for moving a vector at an origin point in the input space along a path to a destination point in the input space in order to produce a vector at said destination point and said parallel transfer procedure being determined by processing said selected input data and said determined metric;
d) starting at points along the resulting geodesic path and repeatedly parallel transferring δ\tilde{x}₍ᵢ₎ for i=2, . . . , n along δ\tilde{x}₍₂₎;
e) for successively increasing values of j in the range 3≦j≦n−1, starting at points along the geodesic paths produced by parallel transfer along δ\tilde{x}₍ⱼ₋₁₎ and repeatedly parallel transferring the δ\tilde{x}₍ᵢ₎ for i=j, . . . , n along δ\tilde{x}₍ⱼ₎;
f) starting at points along the geodesic paths produced by repeated parallel transfer along δ\tilde{x}₍ₙ₋₁₎ and repeatedly parallel transferring δ\tilde{x}₍ₙ₎ along δ\tilde{x}₍ₙ₎;
g) assigning coordinates s to each point in a predetermined neighborhood of \tilde{x}₀, each component sₖ (k=1, . . . , n) of said assigned coordinates s being determined by processing the number of parallel transfers of the vector δ\tilde{x}₍ₖ₎ that was used to reach each point in a predetermined collection of points near said each point in said predetermined neighborhood of \tilde{x}₀; and
h) processing the assigned coordinates s of said points in said neighborhood of \tilde{x}₀ and the \tilde{x} coordinates of said points in said neighborhood of \tilde{x}₀ to determine the coordinate transformation from said \tilde{x} coordinate system to said s coordinate system on the input space near the input locations.

9. The method according to claim 8 wherein parallel transfer of a vector \tilde{V} at point \tilde{x} in said input space along a line segment δ\tilde{x} in said input space produces the vector \tilde{V}+δ\tilde{V} at point \tilde{x}+δ\tilde{x} in said input space, δ\tilde{V} being
δ\tilde{V}^{k}=\tilde{Γ}ₗₘ^{k}(\tilde{x})\tilde{V}^{l}δ\tilde{x}ₘ,
δ\tilde{V}^{k} being the k^{th} component of δ\tilde{V}, \tilde{V}^{k} being the k^{th} component of \tilde{V}, δ\tilde{x}ₖ being the k^{th} component of δ\tilde{x}, \tilde{Γ}ₗₘ^{k}(\tilde{x}) being the affine connection at point \tilde{x},
$${\tilde{Γ}}_{l m}^{k} ( \tilde{x} ) = \frac{1}{2} {\tilde{g}}^{ki} ( \frac{\partial {\tilde{g}}_{il}}{\partial {\tilde{x}}_{m}} + \frac{\partial {\tilde{g}}_{im}}{\partial {\tilde{x}}_{l}} - \frac{\partial {\tilde{g}}_{l m}}{\partial {\tilde{x}}_{i}} ) ,$$
\tilde{g}^{kl} being said metric in said \tilde{x} coordinate system, \tilde{g}ₖₗ being the matrix inverse of \tilde{g}^{kl}, all quantities being evaluated at \tilde{x}, k, l and m being integers in the range 1≦k, l, m≦n, and repeated indices being summed from 1 to n.

10. The method according to claim 8 wherein said n linearly independent local vectors δ\tilde{x}₍ᵢ₎ at \tilde{x}₀ are determined by:
a) determining a set of local projectors at \tilde{x}₀, each said projector Ã^{k}ₗ(\tilde{x}₀) approximately satisfying the conditions
Ã^{k}_{k′}(\tilde{x}₀)Ã^{k′}ₗ(\tilde{x}₀)=Ã^{k}ₗ(\tilde{x}₀),
Ã^{k}ₖ(\tilde{x}₀)=n_{A},
\tilde{R}^{j}ₖₗₘ(\tilde{x}₀)Ã^{k}ᵢ(\tilde{x}₀)−Ã^{j}ₖ(\tilde{x}₀)\tilde{R}^{k}ᵢₗₘ(\tilde{x}₀)=0,
n_{A} being an integer in the range 1≦n_{A}<n, \tilde{R}^{k}ₗₘᵢ(\tilde{x}₀) being approximately determined by
$${\tilde{R}}_{lmi}^{k} ( {\tilde{x}}_{0} ) = - \frac{\partial {\tilde{Γ}}_{l m}^{k}}{\partial {\tilde{x}}_{i}} + \frac{\partial {\tilde{Γ}}_{li}^{k}}{\partial {\tilde{x}}_{m}} + {\tilde{Γ}}_{jm}^{k} {\tilde{Γ}}_{li}^{j} - {\tilde{Γ}}_{ji}^{k} {\tilde{Γ}}_{l m}^{j} ,$$
\tilde{Γ}ₗₘ^{k} being the affine connection at point \tilde{x}₀,
$${\tilde{Γ}}_{l m}^{k} ( {\tilde{x}}_{0} ) = \frac{1}{2} {\tilde{g}}^{ki} ( \frac{\partial {\tilde{g}}_{il}}{\partial {\tilde{x}}_{m}} + \frac{\partial {\tilde{g}}_{im}}{\partial {\tilde{x}}_{l}} - \frac{\partial {\tilde{g}}_{l m}}{\partial {\tilde{x}}_{i}} ) ,$$
\tilde{g}^{kl} being said metric in said \tilde{x} coordinate system, \tilde{g}ₖₗ being the matrix inverse of \tilde{g}^{kl}, all quantities being evaluated at \tilde{x}₀, i, j, k, l and m being integers in the range 1≦i, j, k, l, m≦n, and repeated indices being summed from 1 to n;
b) determining for each said projector Ã^{k}ₗ(\tilde{x}₀) a set of n_{A} linearly independent subspace vectors δ\tilde{x}₍ₐ₎ (a=1, . . . , n_{A}) at \tilde{x}₀ that approximately satisfy
Ã^{k}ₗ(\tilde{x}₀)δ\tilde{x}₍ₐ₎ₗ=δ\tilde{x}₍ₐ₎ₖ,
δ\tilde{x}₍ₐ₎ₖ being the k^{th} component of δ\tilde{x}₍ₐ₎, n_{A} being an integer approximately equal to Ã^{k}ₖ(\tilde{x}₀), k being an integer in the range 1≦k≦n, and repeated indices being summed from 1 to n; and
c) determining the collection of said n linearly independent local vectors δ\tilde{x}₍ᵢ₎ at \tilde{x}₀ to be a collection including all said subspace vectors for all said projectors.

11. The method according to claim 8 wherein said n linearly independent local vectors δ\tilde{x}₍ᵢ₎ at \tilde{x}₀ are selected to satisfy \tilde{g}ₖₗ(\tilde{x}₀)δ\tilde{x}₍ᵢ₎ₖδ\tilde{x}₍ⱼ₎ₗ=λ²δᵢⱼ, \tilde{g}ₖₗ being the matrix inverse of \tilde{g}^{kl}, \tilde{g}^{kl} being said metric in said \tilde{x} coordinate system, δ\tilde{x}₍ᵢ₎ₖ being the k^{th} component of δ\tilde{x}₍ᵢ₎, λ being a predetermined small number, δᵢⱼ being the Kronecker delta, i and j being integers in the range 1≦i, j≦n, and repeated indices being summed from 1 to n.

12. The method according to claim 5 wherein said coordinate transformation from said \tilde{x} coordinate system to said s coordinate system is determined by:
a) determining at each point in a set of predetermined points \tilde{x}₍ᵢ₎ (i=1, 2, . . . ) the values of a local projector, said local projector Ã^{k}ₗ(\tilde{x}₍ᵢ₎) at each said point approximately satisfying the conditions
Ã^{k}_{k′}(\tilde{x}₍ᵢ₎)Ã^{k′}ₗ(\tilde{x}₍ᵢ₎)=Ã^{k}ₗ(\tilde{x}₍ᵢ₎),
Ã^{k}ₖ(\tilde{x}₍ᵢ₎)=n_{A},
n_{A} being an integer in the range 1≦n_{A}<n, k and l being integers in the range 1≦k, l ≦n, and repeated indices being summed from 1 to n;
b) determining at each \tilde{x}₍ᵢ₎ a local complimentary projector \tilde{B}^{k}ₗ(\tilde{x}₍ᵢ₎) corresponding to said local projector Ã^{k}ₗ(\tilde{x}₍ᵢ₎), said complimentary projector at each said point \tilde{x}₍ᵢ₎ being approximately determined by
\tilde{B}^{k}ₗ₍\tilde{x}₍ᵢ₎)=δₗ^{k}−Ã^{k}ₗ(\tilde{x}₍ᵢ₎),
δₗ^{k} being the Kronecker delta, and k and l being integers in the range 1≦k, l≦n;
c) processing said input data and said determined metric and said complimentary projector \tilde{B}^{k}ₗ(\tilde{x}₍ᵢ₎) at each said point \tilde{x}₍ᵢ₎ to determine a set of subspaces of said input space, each subspace having n_{B} dimensions, n_{B} being an integer approximately equal to \tilde{B}^{k}ₖ(\tilde{x}₍ᵢ₎) and local vectors δ\tilde{x} within each said subspace at each point \tilde{x} approximately satisfying
\tilde{B}^{k}ₗ(\tilde{x})δ\tilde{x}ₗ=δ\tilde{x}ₖ,
δ\tilde{x}ₖ being the k^{th} component of δ\tilde{x}, k being an integer in the range 1≦k≦n, repeated indices being summed from 1 to n, and \tilde{B}^{k}ₗ(\tilde{x}) being determined by processing said complimentary projectors at points near \tilde{x};
d) determining n_{A} components of the s coordinates of a set of predetermined points in each said subspace to be a set of n_{A} predetermined numbers assigned to said each said subspace, said set of n_{A} predetermined numbers being different for different said subspaces;
e) processing said n_{A} components of said s coordinates of said predetermined points in said subspaces to determine the n_{A} components of the s coordinates of each point in another set of predetermined points in the input space;
f) repeating steps (a)-(e) in order to determine other components of said s coordinates of each point in said another set of predetermined points in the input space; and
g) using the determined s coordinates of the points in said another set of predetermined points in the input space and the \tilde{x} coordinates of said points to determine the coordinate transformation from said \tilde{x} coordinate system to said s coordinate system.

13. The method according to claim 12 wherein said local projector Ã^{k}ₗ(\tilde{x}₍ᵢ₎) at at least one of said predetermined points \tilde{x}₍ᵢ₎ is determined by parallel transfer of a local projector at another point in the input space to said at least one of said predetermined points, said local projector at said another point and said parallel transfer operation being determined by processing the input data and said determined metric.

14. The method according to claim 13 wherein parallel transfer of a projector Ã^{k}ₗ at point \tilde{x} in said input space along a line segment δ\tilde{x} in said input space produces the projector Ã^{k}ₗ+δÃ^{k}ₗ at point \tilde{x}+δ\tilde{x} in said input space, δÃ^{k}ₗ being
δÃ^{k}ₗ=−\tilde{Γ}ᵢⱼ^{k}(\tilde{x})Ãⁱᵢδ\tilde{x}ⱼ
δ\tilde{x}ₖ being the k^{th} component of δ\tilde{x}, \tilde{Γ}ₗₘ^{k}(\tilde{x}) being the affine connection at point \tilde{x},
$${\tilde{Γ}}_{l m}^{k} ( \tilde{x} ) = \frac{1}{2} {\tilde{g}}^{ki} ( \frac{\partial {\tilde{g}}_{il}}{\partial {\tilde{x}}_{m}} + \frac{\partial {\tilde{g}}_{im}}{\partial {\tilde{x}}_{l}} - \frac{\partial {\tilde{g}}_{l m}}{\partial {\tilde{x}}_{i}} ) ,$$
\tilde{g}^{kl} being said metric in said \tilde{x} coordinate system, \tilde{g}ₖₗ being the matrix inverse of \tilde{g}^{kl}, all quantities being evaluated at \tilde{x}, k, l, and m, being integers in the range 1≦k, l, m≦n, and repeated indices being summed from 1 to n.

15. The method according to claim 12 wherein each said projector Ã^{k}ₗ(\tilde{x}₍ᵢ₎) at each said predetermined point \tilde{x}₍ᵢ₎ is determined to approximately satisfy
Ã^{k}_{l;m}(\tilde{x}₍ᵢ₎)=0,
Ã^{k}_{l;m}(\tilde{x}₍ᵢ₎) being the covariant derivative of said projector
$${\tilde{A}}_{l ; m}^{k} ( {\tilde{x}}_{( i )} ) = \frac{\partial {\tilde{A}}_{l}^{k}}{\partial {\tilde{x}}_{m}} + {\tilde{A}}_{l}^{i} {\tilde{Γ}}_{im}^{k} - {\tilde{A}}_{i}^{k} {\tilde{Γ}}_{l m}^{i} ,$$
the derivative at \tilde{x}₍ᵢ₎ of Ã^{k}ₗ being evaluated by processing values of Ã^{k}ₗ at points near \tilde{x}₍ᵢ₎, \tilde{Γ}ₗₘ^{k} being the affine connection at point \tilde{x}₍ᵢ₎,
$${\tilde{Γ}}_{l m}^{k} ( {\tilde{x}}_{( i )} ) = \frac{1}{2} {\tilde{g}}^{ki} ( \frac{\partial {\tilde{g}}_{il}}{\partial {\tilde{x}}_{m}} + \frac{\partial {\tilde{g}}_{im}}{\partial {\tilde{x }}_{l}} - \frac{\partial {\tilde{g}}_{l m}}{\partial {\tilde{x}}_{i}} ) ,$$
\tilde{g}^{kl} being said metric in said \tilde{x} coordinate system, \tilde{g}ₖₗ being the matrix inverse of \tilde{g}^{kl}, all quantities being evaluated at \tilde{x}₍ᵢ₎, k, l and m being integers in the range 1≦k, l, m≦n, and repeated indices being summed from 1 to n.

16. The method according to claim 12 wherein said local projector Ã^{k}ₗ(\tilde{x}₍ᵢ₎) at at least one of said predetermined points \tilde{x}₍ᵢ₎ is determined to be an approximate solution of:
\tilde{R}^{q}ₖₗₘ(\tilde{x}₍ᵢ₎)Ã^{k}ₚ(\tilde{x}₍ᵢ₎)−Ã^{q}ₖ(\tilde{x}₍ᵢ₎)\tilde{R}ₚₗₘ(\tilde{x}₍ᵢ₎)=0,
\tilde{R}^{k}ₗₘₚ(\tilde{x}₍ᵢ₎) being approximately determined by
$${\tilde{R}}_{lmp}^{k} ( {\tilde{x}}_{( i )} ) = - \frac{\partial {\tilde{Γ}}_{l m}^{k}}{\partial {\tilde{x}}_{p}} + \frac{\partial {\tilde{Γ}}_{lp}^{k}}{\partial {\tilde{x}}_{m}} + {\tilde{Γ}}_{qm}^{k} {\tilde{Γ}}_{lp}^{q} - {\tilde{Γ}}_{qp}^{k} {\tilde{Γ}}_{l m}^{q} , \\ {\tilde{Γ}}_{l m}^{k} ( {\tilde{x}}_{( i )} ) = \frac{1}{2} {\tilde{g}}^{ki} ( \frac{\partial {\tilde{g}}_{il}}{\partial {\tilde{x}}_{m}} + \frac{\partial {\tilde{g}}_{im}}{\partial {\tilde{x}}_{l}} - \frac{\partial {\tilde{g}}_{l m}}{\partial {\tilde{x}}_{i}} ) ,$$
\tilde{g}^{kl} being said metric in said \tilde{x} coordinate system, \tilde{g}ₖₗ being the matrix inverse of \tilde{g}^{kl}, all quantities being evaluated at \tilde{x}₍ᵢ₎, k, l, m, p and q being integers in the range 1≦k, l, m, p, q≦n, and repeated indices being summed from 1 to n.

17. The method according to claim 12 wherein said local projector Ã^{k}ₗ(\tilde{x}₍ᵢ₎) at at least one of said predetermined points \tilde{x}₍ᵢ₎ is determined by processing the selected input data and said determined metric and other selected input data, said other selected input data being determined by selecting input data at times belonging to a group including at least one of times at which at least one said source system is not producing energy detected by a detector and times at which at least one said source system is not producing information detected by a detector.

18. The method according to claim 17 wherein said local projector Ã^{k}ₗ(\tilde{x}₍ᵢ₎) at said at least one of said predetermined points \tilde{x}₍ᵢ₎ is determined by:
a) determining a local quantity Ã^{kl} at each point \tilde{x}₍ᵢ₎ belonging to the group of said at least one of said predetermined points, Ã^{kl} at point \tilde{x}₍ᵢ₎ being approximately determined by
Ã^{kl}(\tilde{x}₍ᵢ₎)=<( [symbol] − [symbol] )( [symbol] − [symbol] )>_{\tilde{x}}_{₍ᵢ₎},
\tilde{x}(t) being said other selected input data at time t, \tilde{x}ₖ being the k^{th} component of \tilde{x}(t), [symbol] being the time derivative of \tilde{x}(t), [symbol] being the time average of [symbol] over said other selected input data in a predetermined neighborhood of \tilde{x}₍ᵢ₎, the angular brackets denoting the time average of the bracketed quantity over said other selected input data in a predetermined neighborhood of \tilde{x}₍ᵢ₎, and k and l being integers in the range 1≦k, l≦n; and
b) determining Ã^{k}ₗ(\tilde{x}₍ᵢ₎) to be approximately given by
Ã^{k}ₗ(\tilde{x}₍ᵢ₎=Ã^{km}(\tilde{x}₍ᵢ₎)\tilde{g}ₘₗ(\tilde{x}₍ᵢ₎)
\tilde{g}ₖₗ(\tilde{x}₍ᵢ₎) being the matrix inverse of said determined metric \tilde{g}^{kl}(\tilde{x}₍ᵢ₎) at \tilde{x}₍ᵢ₎, the indices k and l being in the range 1≦k, l≦n, and repeated indices being summed from 1 to n.

19. The method according to claim 5 wherein said isometric coordinate transformation is determined so that said selected input data in said x coordinate system approximately satisfies at least one condition of the form
<(xₖ−\tilde{x}ₖ)(xₗ−\tilde{x}ₗ) . . . >=<(xₖ−\tilde{x}ₖ) . . . ><(xₗ−\tilde{x}ₗ) . . . >
<(\dot{x}ₖ− [symbol] ) . . . (\dot{x}ₗ− [symbol] ) . . . >=<(\dot{x}ₖ− [symbol] ) . . . ><(\dot{x}ₗ− [symbol] ) . . . >
<(xₖ−\tilde{x}ₖ) . . . (\dot{x}ₗ− [symbol] ) . . . >=<(xₖ−\tilde{x}ₖ) . . . ><(\dot{x}ₗ− [symbol] ) . . . >
x(t) being the selected input data in the x coordinate system at time t, xₖ being the k^{th} component of x(t), \tilde{x} denoting the time average of x(t) over the selected input data in the x coordinate system, \dot{x} being the time derivative of x(t), [symbol] being the time average of \dot{x} over the selected input data in the x coordinate system, each three dots being a product of factors selected from a group including the number 1 and (xᵢ−\tilde{x}ᵢ) for i=1, . . . , n and (\dot{x}ⱼ− [symbol] ) for j=1, . . . , n, each bracket pair denoting the time average of the quantity in said each bracket pair over the selected input data in the x coordinate system, k and l being predetermined integers in the range 1≦k, l≦n, all of parenthetical quantities on the left side of each equation appearing the same number of times on the right side of said each equation, the indices of the parenthetical quantities inside each bracket pair on said right side being selected from indices corresponding to a group of blocks of said block-diagonal form of said metric in the x coordinate system, each said group containing at least one block, and said group of blocks corresponding to the indices of the parenthetical quantities inside one said bracket pair on said right side containing no blocks from said group of blocks corresponding to the indices of the parenthetical quantities inside the other said bracket pair on said right side.

20. The method according to claim 5 wherein said isometric coordinate transformation is determined so that said selected input data in said x coordinate system approximately satisfies at least one condition of the form
<(\dot{x}ₖ− [symbol] )(\dot{x}ₗ− [symbol] ) . . . >ₓ=<(\dot{x}ₖ− [symbol] ) . . . >ₓ<(\dot{x}ₗ− [symbol] ) . . . >ₓ
x(t) being the selected input data in the x coordinate system at time t, xₖ being the k^{th} component of x(t), \dot{x} being the time derivative of x(t), [symbol] being the time average of x over said selected input data in the x coordinate system in a predetermined neighborhood of a predetermined point x, each three dots being a product of factors selected from a group including the number 1 and (\dot{x}ᵢ− [symbol] ) for i=1, . . . , n, each bracket pair denoting the time average of the quantity in said bracket pair over the selected input data in the x coordinate system in a predetermined neighborhood of said predetermined point x, the indices k and l being predetermined integers in the range 1≦k, l≦n, all of parenthetical quantities on the left side of said equation appearing the same number of times on the right side of said equation, the indices of the parenthetical quantities inside each bracket pair on said right side corresponding to components of the x coordinates in a group of blocks of said block-diagonal form of said metric in the x coordinate system, each said group of blocks containing at least one block, and the group of blocks corresponding to the indices of the parenthetical quantities inside one said bracket pair on said right side containing no blocks from the group of blocks corresponding to the indices of the parenthetical quantities inside the other said bracket pair on said right side.

21. A method of processing time-dependent input data obtained from at least two independently evolving source systems, the method comprising:
a) selecting said source systems;
b) obtaining time-dependent input data from said source systems, each said input datum at each time including n numbers, n being a positive integer, each said input datum at each time being a point in the input space of all possible input data, and the n numbers of each input datum being the coordinates of said point in the \tilde{x} coordinate system of said input space;
c) selecting input locations in said input space;
d) determining selected input data to be a subset of said input data, each datum in said subset being near said input locations and each datum in said subset being selected at one of a group of predetermined times;
e) selecting at least two independently evolving prior systems;
f) obtaining time-dependent prior data from said prior systems, each said prior datum at each time including n numbers, n being a positive integer, each said prior datum at each time being a point in the prior space of all possible prior data, and the n numbers of each prior datum being the coordinates of said point in the x coordinate system of said prior space;
g) selecting prior locations in said prior space;
h) determining selected prior data to be a subset of said prior data, each datum in said subset being near said prior locations, each datum in said subset being selected at one of a group of predetermined times, and said selected prior data having the property that the duration of time for which said selected prior data in said x coordinate system are within a neighborhood of the point x having components xₖ (k=1, . . . , n) and the time derivatives of said selected prior data are within a neighborhood of the point \dot{x} having components \dot{x}ₖ (k=1, . . . , n) is approximately equal to the product of the total time duration of said selected prior data and ρ(x, \dot{x})dxd\dot{x}, dx being the volume of said neighborhood of said point x, d\dot{x} being the volume of said neighborhood of said point \dot{x}, ρ(x, \dot{x}) being the phase space density function, ρ(x, \dot{x}) being approximately equal to the product of at least two factors, each said factor being a function of a subset of said components xₖ and the time derivatives of the components in said subset, and the components in said subset corresponding to one said factor not belonging to said subset of components corresponding to every other said factor;
i) processing the input data and said selected prior data to determine a coordinate transformation x(\tilde{x}) from said \tilde{x} coordinate system on said input space near said input locations to an x coordinate system on the input space near said input locations, said transformation having the property that the duration of time for which said selected input data in the x coordinate system of said input space are within a neighborhood of the point x having components xₖ (k=1, . . . , n) and the time derivatives of said selected input data in said input space are within a neighborhood of the point \dot{x} having components \dot{x}ₖ (k=1, . . . , n) is approximately equal to the product of the total time duration of said selected input data and ρ(x, \dot{x})dxd\dot{x}, ρ(x, \dot{x}) being said phase space density function, dx being the volume of said neighborhood of said point x, and d\dot{x} being the volume of said neighborhood of said point \dot{x};
j) transforming at least a portion of said selected input data from said \tilde{x} coordinate system to said x coordinate system on said input space; and
k) determining information about a group of at least one source system by processing a predetermined set of coordinate components of said portion of said selected input data in said x coordinate system, said predetermined set of coordinate components corresponding to at least one said subset of components.

22. The method according to claim 21 wherein the set of selected input locations is selected from a group including a set of locations that are near all of the input data and a set of locations that are near a predetermined subset of the input data.

23. The method according to claim 21 wherein the set of selected prior locations is selected from a group including a set of locations that are near all of the prior data and a set of locations that are near a predetermined subset of the prior data.

24. The method according to claim 21 wherein said selected prior data are similar to said selected input data, said similarity including the property that there is a coordinate transformation x(\tilde{x}) from said \tilde{x} coordinate system on said input space near said input locations to an x coordinate system on the input space near said input locations, said transformation having the property that the duration of time for which said selected input data in said x coordinate system of said input space are within a neighborhood of the point x having components xₖ (k=1, . . . , n) and the time derivatives of said selected input data in said input space are within a neighborhood of the point \dot{x} having components \dot{x}ₖ (k=1, . . . , n) is approximately equal to the product of the total time duration of said selected input data and ρ(x, \dot{x})dxd\dot{x}, ρ(x, \dot{x}) being said phase space density function, dx being the volume of said neighborhood of said point x, and d\dot{x} being the volume of said neighborhood of said point \dot{x}.

25. The method according to claim 21 wherein said coordinate transformation x(\tilde{x}) is determined to be a function x(\tilde{x}) that approximately satisfies \tilde{S}₍ᵢ₎(\tilde{x})=S₍ᵢ₎(x(\tilde{x})) for i=1, 2, . . . , n_{S} at each point \tilde{x} in said \tilde{x} coordinate system on said input space near said input locations, each said \tilde{S}₍ᵢ₎(\tilde{x}) being a scalar function in said \tilde{x} coordinate system on said input space obtained by processing said selected input data, each said S₍ᵢ₎(x) being a scalar function in said x coordinate system on said prior space obtained by processing said selected prior data, and n_{S} being a positive integer.

26. The method according to claim 25 wherein at least one said scalar function \tilde{S}₍ᵢ₎(\tilde{x}) at each point x near said input locations in said input space is determined to approximately be \tilde{S}₍ᵢ₎(\tilde{x})=\tilde{T}₍ᵢ₎(\tilde{x}) and at least one said scalar function S₍ᵢ₎(x) at each point x near said prior locations in said prior space is determined to approximately be S₍ᵢ₎(x)=T₍ᵢ₎(x), \tilde{T}₍ᵢ₎(\tilde{x}) and T₍ᵢ₎(x) being determined by:
a) processing said selected input data to determine the values at each said point \tilde{x} of at least two components, each said component being a component of a tensor density quantity in said \tilde{x} coordinate system on said input space near said input locations;
b) selecting a set of algebraic constraints on a predetermined subset of said components at each said point \tilde{x}, said constraints at said point \tilde{x} being approximately satisfied in a non-empty set of other coordinate systems on said input space, and at least one tensor density component at said point \tilde{x} having the property that its value is approximately equal to a same value in all of said other coordinate systems;
c) determining \tilde{T}₍ᵢ₎(\tilde{x}) to be approximately equal to said same value of a predetermined one of said at least one tensor density component;
d) processing said selected prior data to determine the values at each said point x in said prior space of at least two components, each said component being a component of a tensor density quantity in said x coordinate system on said prior space near said selected prior locations;
e) selecting a set of algebraic constraints on a predetermined subset of said components at each said point x, said constraints at said point x being approximately satisfied in a non-empty set of other coordinate systems on said prior space, and at least one tensor density component at said point x having the property that it's value is approximately equal to a same value in all of said other coordinate systems; and
f) determining T₍ᵢ₎(x) to be approximately equal to said same value of a predetermined one of said at least one tensor density component.

27. The method according to claim 26 wherein at least one said tensor density quantity in said \tilde{x} coordinate system at a point \tilde{x} in said input space is selected from a group including the local average velocity of said selected input data [symbol] =< [symbol] >_{\tilde{x}}, said metric tensor \tilde{g}^{kl} on said input space
\tilde{g}^{kl}(\tilde{x})=<( [symbol] − [symbol] )( [symbol] − [symbol] )>_{\tilde{x}},
the matrix inverse \tilde{g}^{kl} of said metric tensor, local velocity correlations of the form
<( [symbol] − [symbol] )( [symbol] − [symbol] )( [symbol] − [symbol] ) . . . >_{\tilde{x}},
covariant derivatives of these tensor densities, and tensor densities created from algebraic combinations of the components of these tensor densities and ordinary partial derivatives of said components, including the Riemann-Christoffel curvature tensor \tilde{R}^{k}ₗₘₚ(\tilde{x})
$${\tilde{R}}_{lmp}^{k} ( \tilde{x} ) = - \frac{\partial {\tilde{Γ}}_{l m}^{k}}{\partial {\tilde{x}}_{p}} + \frac{\partial {\tilde{Γ}}_{lp}^{k}}{\partial {\tilde{x}}_{m}} + {\tilde{Γ}}_{qm}^{k} {\tilde{Γ}}_{lp}^{q} - {\tilde{Γ}}_{qp}^{k} {\tilde{Γ}}_{l m}^{q} , \\ {\tilde{Γ}}_{l m}^{k} ( \tilde{x} ) = \frac{1}{2} {\tilde{g}}^{ki} ( \frac{\partial {\tilde{g}}_{il}}{\partial {\tilde{x}}_{m}} + \frac{\partial {\tilde{g}}_{im}}{\partial {\tilde{x}}_{l}} - \frac{\partial {\tilde{g}}_{l m}}{\partial {\tilde{x}}_{i}} ) ,$$
\tilde{x}(t) being said selected input data at time t, [symbol] being the time derivative of \tilde{x}(t), [symbol] being the time average of [symbol] over the selected input data in a predetermined neighborhood of said location \tilde{x}, \tilde{x}ₖ being the k^{th} component of \tilde{x}(t), the angular brackets denoting the time average of the bracketed quantity over the selected input data in a predetermined neighborhood of said location \tilde{x}, the three dots being a product of factors selected from the group including 1 and ( [symbol] − [symbol] ) for i=1, . . . , n, all quantities being evaluated at \tilde{x}, and k, l, m, and p being integers in the range 1≦k, l, m, p≦n.

28. The method according to claim 26 wherein at least one said tensor density quantity in said x coordinate system at a point x in said prior space is selected from a group including the local average velocity of said selected prior data [symbol] =<\dot{x}>ₓ, the metric tensor g^{kl} on said prior space
g^{kl}(x)=<(\dot{x}ₖ− [symbol] )(\dot{x}ₗ− [symbol] )>ₓ,
the matrix inverse gₖₗ of said metric tensor, local velocity correlations of the form
<(\dot{x}ₖ− [symbol] )(\dot{x}ₗ− [symbol] )(\dot{x}ₘ− [symbol] ) . . . >ₓ,
covariant derivatives of these tensor densities, and tensor densities created from algebraic combinations of the components of these tensor densities and ordinary partial derivatives of said components, including the Riemann-Christoffel curvature tensor R^{k}ₗₘₚ(x)
$${R}_{lmp}^{k} ( x ) = - \frac{\partial {Γ}_{l m}^{k}}{\partial {x}_{p}} + \frac{\partial {Γ}_{lp}^{k}}{\partial {x}_{m}} + {Γ}_{qm}^{k} {Γ}_{lp}^{q} - {Γ}_{qp}^{k} {Γ}_{l m}^{q} , \\ {Γ}_{l m}^{k} ( x ) = \frac{1}{2} {g}^{ki} ( \frac{\partial {g}_{il}}{\partial {x}_{m}} + \frac{\partial {g}_{im}}{\partial {x}_{l}} - \frac{\partial {g}_{l m}}{\partial {x}_{i}} ) ,$$
ₚ(t) being said selected prior data at time t, \dot{x} being the time derivative of x_{P}(t), [symbol] being the time average of \dot{x} over the selected prior data in a predetermined neighborhood of said location x, xₖ being the k^{th} component of xₚ(t), the angular brackets denoting the time average of the bracketed quantity over the selected prior data in a predetermined neighborhood of said location x, the three dots being a product of factors selected from the group including 1 and (\dot{x}ᵢ− [symbol] ) for i=1, . . . , n, all quantities being evaluated at x, and k, l, m, and p being integers in the range 1≦k, l, m, p≦n.

29. The method according to claim 25 wherein at least one said scalar function \tilde{S}₍ᵢ₎(\tilde{x}) is determined to approximately be \tilde{S}₍ᵢ₎(\tilde{x})=\tilde{s}ᵢ(\tilde{x}) and at least one said scalar function S₍ᵢ₎(x) is determined to approximately be S₍ᵢ₎(x)=sᵢ(x), \tilde{s}ᵢ(\tilde{x}) being the i^{th} component of the geodesic coordinates of point \tilde{x} in said \tilde{x} coordinate system on said input space, \tilde{s}ᵢ(\tilde{x}) being determined by processing said selected input data and landmark points in said input space, \tilde{x}₍ᵢ₎ for i=0,1, . . . ñ_{L} being said landmark points in said input space in said \tilde{x} coordinate system, ñ_{L} being a positive integer, sᵢ(x) being the i^{th} component of the geodesic coordinates of point x in said x coordinate system on said prior space, sᵢ(x) being determined by processing said selected prior data and landmark points in said prior space, x₍ᵢ₎ for i=0,1, . . . , n_{L} being said landmark points in said prior space in said x coordinate system, and n_{L} being a positive integer.

30. The method according to claim 29 wherein at least one said \tilde{x}₍ᵢ₎ and at least one said x₍ᵢ₎ are determined so that they approximately satisfy x₍ᵢ₎=x(\tilde{x}₍ᵢ₎), said x(\tilde{x}) being said coordinate transformation from said \tilde{x} coordinate system on said input space to said x coordinate system on said input space.

31. The method according to claim 29 wherein said geodesic coordinates of points in said input space are determined in said \tilde{x} coordinate system by:
a) determining a reference point \tilde{x}₀ in said \tilde{x} coordinate system on said input space, said reference point \tilde{x}₀ being determined by processing the input data and said landmark points in said input space;
b) determining n linearly independent local vectors δ\tilde{x}₍ᵢ₎ (i=1, . . . , n) at \tilde{x}₀, said local vectors δ\tilde{x}₍ᵢ₎ being determined by processing the input data and said landmark points in said input space;
c) starting at \tilde{x}₀ and repeatedly parallel transferring the δ\tilde{x}₍ᵢ₎ for i=1, . . . , n along δ\tilde{x}₍₁₎, said parallel transfer being a procedure for moving a vector at an origin point in said input space along a path to a destination point in said input space in order to produce a vector at said destination point and said parallel transfer procedure being determined by processing said selected input data;
d) starting at points along the resulting geodesic path and repeatedly parallel transferring δ\tilde{x}₍ᵢ₎ for i=2, . . . , n along δ\tilde{x}₍₂₎;
e) for successively increasing values of j in the range 3≦j≦n−1, starting at points along the geodesic paths produced by parallel transfer along δ\tilde{x}₍ⱼ₋₁₎ and repeatedly parallel transferring the δ\tilde{x}₍ᵢ₎ for i=j, . . . , n along δ\tilde{x}₍ⱼ₎;
f) starting at points along the geodesic paths produced by repeated parallel transfer along δ\tilde{x}₍ₙ₋₁₎ and repeatedly parallel transferring δ\tilde{x}₍ₙ₎ along δ\tilde{x}₍ₙ₎;
g) assigning coordinates s to each point \tilde{x} in a predetermined neighborhood of \tilde{x}₀, each component sᵢ (i=1, . . . , n) of said assigned coordinates s being determined by processing the number of parallel transfers of said vector δ\tilde{x}₍ᵢ₎ that was used to reach each point in a predetermined collection of points near said each point \tilde{x} in a predetermined neighborhood of \tilde{x}₀; and
h) determining said function \tilde{s}ᵢ(\tilde{x}) to have a value at point \tilde{x}, said value being approximately equal to said component sᵢ of said assigned coordinates assigned to \tilde{x}.

32. The method according to claim 31 wherein parallel transfer of a vector \tilde{V} at point \tilde{x} in said input space along a line segment δ\tilde{x} in said input space produces the vector \tilde{V}+δ\tilde{V} at point \tilde{x}+δ\tilde{x} in said input space, δ\tilde{V} being
δ\tilde{V}^{k}=−\tilde{Γ}ₗₘ^{k}(\tilde{x})\tilde{V}^{l}δ\tilde{x}ₘ,
δ\tilde{V}^{k} being the k^{th} component of δ\tilde{V}, \tilde{V}^{k} being the k^{th} component of \tilde{V}, δ\tilde{x}ₖ being the k^{th} component of δ\tilde{x}, \tilde{Γ}ₗₘ^{k}(\tilde{x}) being the affine connection at point \tilde{x},
$${\tilde{Γ}}_{l m}^{k} ( \tilde{x} ) = \frac{1}{2} {\tilde{g}}^{ki} ( \frac{\partial {\tilde{g}}_{il}}{\partial {\tilde{x}}_{m}} + \frac{\partial {\tilde{g}}_{im}}{\partial {\tilde{x}}_{l}} - \frac{\partial {\tilde{g}}_{l m}}{\partial {\tilde{x}}_{i}} ) ,$$
all quantities being evaluated at location \tilde{x}, \tilde{g}ₖₗ being the matrix inverse of \tilde{g}^{kl}, \tilde{g}^{kl} being said metric in said \tilde{x} coordinate system, k, l and m being integers in the range 1≦k, l, m≦n, and repeated indices being summed from 1 to n.

33. The method according to claim 31 wherein said reference point \tilde{x}₀ is determined to be a predetermined one \tilde{x}₍₀₎ of said landmark points in said input space and at least one said reference vector δ\tilde{x}₍ᵢ₎ is determined to be a small vector at said reference point \tilde{x}_{0,}a path from said reference point to a predetermined one \tilde{x}₍ᵢ₎ of said landmark points being produced when said small vector is parallel transferred along itself a predetermined number of times, and i being an integer in the range 1≦i≦ñ_{L}.

34. The method according to claim 29 wherein said geodesic coordinates of points in said prior space are determined in said x coordinate system on said prior space by:
a) determining a reference point \tilde{x}₀ in said x coordinate system on said prior space, said reference point x₀ being determined by processing said selected prior data and said landmark points in said prior space;
b) determining n linearly independent local vectors δx₍ᵢ₎ (i=1, . . . , n) at x₀, said local vectors δx₍ᵢ₎ being determined by processing said selected prior data and said landmark points in said prior space;
c) starting at x₀ and repeatedly parallel transferring the δx₍ᵢ₎ for i=1, . . . , n along δx₍₁₎, said parallel transfer being a procedure for moving a vector at an origin point in the prior space along a path to a destination point in the prior space in order to produce a vector at said destination point and said parallel transfer procedure being determined by processing said selected prior data;
d) starting at points along the resulting geodesic path and repeatedly parallel transferring δx₍ᵢ₎ for i=2, . . . , n along δx₍₂₎;
e) for successively increasing values of j in the range 3≦j≦n−1, starting at points along the geodesic paths produced by parallel transfer along δx₍ⱼ₋₁₎ and repeatedly parallel transferring the δx₍ᵢ₎ for i=j, . . . , n along δx₍ⱼ₎;
f) starting at points along the geodesic paths produced by repeated parallel transfer along δx₍ₙ₋₁₎ and repeatedly parallel transferring δx₍ₙ₎ along δx₍ₙ₎;
g) assigning coordinates s to each point x in a predetermined neighborhood of x₀, each component sᵢ (i=1, . . . , n) of said assigned coordinates s being determined by processing the number of parallel transfers of the vector δx₍ᵢ₎ that was used to reach each point in a predetermined collection of points near said each point x in a predetermined neighborhood of x₀; and
h) determining said function sᵢ(x) to have a value at point x, said value being approximately equal to said component sᵢ of said assigned coordinates assigned to x.

35. The method according to claim 34 wherein parallel transfer of a vector V at point x in said prior space along a line segment δx in said prior space produces the vector V+δV at point x+δx in said prior space, δV being
δV^{k}=−Γₗₘ^{k}(x)V^{l}δxₘ,
δV^{k} being the k^{th} component of δV, V^{k} being the k^{th} component of V, δxₖ being the k^{th} component of δx, Γₗₘ^{k}(x) being the affine connection at point x,
$${Γ}_{l m}^{k} ( x ) = \frac{1}{2} {g}^{ki} ( \frac{\partial {g}_{il}}{\partial {x}_{m}} + \frac{\partial {g}_{im}}{\partial {x}_{l}} - \frac{\partial {g}_{l m}}{\partial {x}_{i}} ) ,$$
all quantities being evaluated at location x, gₖₗ being the matrix inverse of g^{kl}, g^{kl} being the metric in said x coordinate system on said prior space,
g^{kl}(x)=<(\dot{x}ₖ− [symbol] )(\dot{x}ₗ− [symbol] )>ₓ,
xₚ(t) being said selected prior data at time t, xₖ being the k^{th} component of xₚ(t), \dot{x} being the time derivative of xₚ(t), [symbol] being the time average of \dot{x} over the selected prior data in a predetermined neighborhood of said location x, the angular brackets denoting the time average of the bracketed quantity over the selected prior data in a predetermined neighborhood of said location x, k, l and m being integers in the range 1≦k, l, m≦n, and repeated indices being summed from 1 to n.

36. The method according to claim 34 wherein said reference point x₀ is determined to be a predetermined one x₍₀₎ of said landmark points in said prior space and at least one said reference vector δx₍ᵢ₎ is determined to be a small vector at said reference point x₀, a path from said reference point to a predetermined one x₍ᵢ₎ of said landmark points being produced when said small vector is parallel transferred along itself a predetermined number of times, and i being an integer in the range 1≦i≦n_{L}.

37. The method according to claim 21 wherein said coordinate transformation x(\tilde{x}) is determined to be a function x(\tilde{x}) that approximately satisfies x(\tilde{x})=x(y(\tilde{x})), x(y) being a predetermined function, y(\tilde{x}) being determined to be a function that approximately satisfies \tilde{S}₍ᵢ₎(\tilde{x})=S₍ᵢ₎(y(\tilde{x})) for i=1, 2, . . . , n_{S} at each point \tilde{x} in said \tilde{x} coordinate system on said input space near said input locations, each said \tilde{S}₍ᵢ₎(\tilde{x}) being a scalar function in said \tilde{x} coordinate system on said input space obtained by processing said selected input data, x(y) being the transformation between a y coordinate system on said prior space and said x coordinate system on said prior space, each said S₍ᵢ₎(y) being a scalar function in said y coordinate system on said prior space obtained by processing y(t), y(t) being said selected prior data at time t in said y coordinate system on said prior space, and n_{S} being a positive integer.

38. A computer-readable storage medium having processor executable instructions to process time-dependent input data obtained from at least two independently evolving source systems by performing the acts of:
a) selecting said source systems;
b) obtaining time-dependent input data from said source systems, each said input datum at each time including n numbers, n being a positive integer, each said input datum at each time being a point in the input space of all possible input data, and the n numbers of each input datum being the coordinates of said point in the \tilde{x} coordinate system of said input space;
c) selecting input locations in said input space;
d) determining selected input data to be a subset of said input data, each datum in said subset being near said input locations and each datum in said subset being selected at one of a group of predetermined times;
e) processing said input data to determine a coordinate transformation from said \tilde{x} coordinate system on the input space near said input locations to an x coordinate system on the input space near said input locations, said x coordinate system having the property that the duration of time for which said selected input data in the x coordinate system are within a neighborhood of the point x having components xₖ (k=1, . . . , n) and the time derivatives of said selected input data are within a neighborhood of the point \dot{x} having components \dot{x}ₖ (k=1, . . . , n) is approximately equal to the product of the total time duration of said selected input data and ρ(x, \dot{x})dxd\dot{x}, dx being the volume of said neighborhood of said point x, d\dot{x} being the volume of said neighborhood of said point \dot{x}, ρ(x, \dot{x}) being approximately equal to the product of at least two factors, each said factor being a function of a subset of said components xₖ and the time derivatives of the components in said subset, and the components in said subset corresponding to one said factor not belonging to said subset of components corresponding to any other said factor;
f) transforming at least a portion of said selected input data from said \tilde{x} coordinate system to said x coordinate system on said input space; and
g) determining information about a group of at least one source system by processing a predetermined set of coordinate components of said portion of said selected input data in said x coordinate system, said predetermined set of coordinate components including at least one said subset of components.
